(19) United States
(12) Patent Application Publication
(10) Pub. No.: US 2020/0104829 A1
(43) Pub. Date: Apr. 2, 2020

(54) METHODS AND SYSTEMS FOR REDEEMING A GIFT CARD AT A MERCHANT TERMINAL

(71) Applicant: MASTERCARD INTERNATIONAL INCORPORATED, Purchase, NY (US)

(72) Inventors: Ankur Arora, New Delhi (IN); Rakesh Patel, Gurgaon (IN); Aditya Koduri, Gurgaon (IN)

(73) Assignee: MASTERCARD INTERNATIONAL INCORPORATED, Purchase, NY (US)

(21) Appl. No.: 16/563,379

(22) Filed: Sep. 6, 2019

(30) Foreign Application Priority Data
Sep. 28, 2018 (SG) 10201808578S

(51) Int. Cl. G06Q 20/34; G06Q 20/12; G06Q 20/20

(52) U.S. Cl. CPC G06Q 20/342; G06Q 20/12; G06Q 20/385; G06Q 20/202; G06Q 20/354

(57) ABSTRACT

Embodiments provide methods, server systems and devices for redeeming a gift card at a merchant terminal. The method includes receiving, by a server system associated with a payment network, a payment transaction request from the merchant terminal. The payment transaction request includes a first information associated with a merchant, a second information associated with a payment card of a customer and a transaction amount to be paid to a merchant account. The method also includes detecting if at least one gift card with a gift balance amount associated with the merchant is already linked with the payment card. The method further includes sending an approval request to redeem at least a part of the gift balance amount for the transaction amount to the customer. The method includes processing payment of the transaction amount using at least the part of the gift balance amount upon receiving an approval from the customer.

### TECHNICAL FIELD

The present disclosure relates to financial transactions and, more particularly to, methods and systems for redeeming gift cards at merchant terminals.

### BACKGROUND

Gift cards are a convenient way to give gifts to people when it is difficult to choose a gift that the person may like. Moreover, gift cards encourage people who might not otherwise visit a business to take a look around and likely return to make additional purchases and thereby increasing sales of the business. Digital gift cards have become increasingly popular as consumers grow more accustomed to using mobile payments, mobile wallets and apps to conduct financial transactions. At the same time, digital gift card programs provide consumers with an easy way to shop online or in-store and track gift card balances. However, gift cards come with an expiry date and the consumers must remember to redeem the gift cards before the expiry schedule of the gift cards. However, retailers use gift cards as a part of their marketing strategy to get new customers and retain loyal customers.

Physical gift cards resemble a credit card and may include a card identifier that can be read by an automated reading machine. However, some gift cards offered by retailers (or businesses) ensure that the customer redeems such gift cards only at the business that issued the gift card. In an example scenario, if the customer had received more than one gift cards for different businesses on an occasion, say, birthday, the consumer will have to physically carry the gift cards around everywhere and remember to redeem the gift cards when he/she makes a purchase at the business. This requires the consumer to carry all the gift cards to his wallet and to remember to use the gift card at the business while making a purchase.

Based on the foregoing discussion, there is a need for techniques where customers are able to redeem gift cards without the need for physically carrying the gift card and remembering to redeem the gift cards that are valid only at particular businesses.

### SUMMARY

Various embodiments of the present disclosure provide systems, methods, electronic devices and computer program products for redeeming a gift card at a merchant terminal.

In an embodiment, a method is disclosed. The method includes receiving, by a server system associated with a payment network, a payment transaction request from a merchant terminal. The payment transaction request includes a first information associated with a merchant, a second information associated with a payment card of a customer and a transaction amount to be paid to a merchant account from an issuer account of the customer. The method also includes detecting, by the server system, if at least one gift card with a gift balance amount associated with the merchant is already linked with the payment card of the customer upon receiving the payment transaction request. The method further includes sending, by the server system, an approval request to redeem at least a part of the gift balance amount for the transaction amount to the customer. The method includes processing, by the server system, a payment of the transaction amount using at least the part of the gift balance amount upon receiving an approval from the customer in response to the approval request.

In another embodiment, a server system associated with a payment network is disclosed. The server system includes a memory comprising stored instructions and at least one processor configured to execute the stored instructions to cause a server system to perform a method. The method includes receiving a payment transaction request from a merchant terminal. The payment transaction request includes a first information associated with a merchant, a second information associated with a payment card of the customer and a transaction amount to be paid to a merchant account from an issuer account of the customer. The method also includes detecting if at least one gift card with a gift balance amount associated with the merchant is already linked with the payment card of the customer upon receiving the payment transaction request. The method further includes sending an approval request to redeem at least a part of the gift balance amount for the transaction amount to the customer. The method includes processing a payment of the transaction amount using at least the part of the gift balance amount upon receiving an approval from the customer in response to the approval request.

In another embodiment, a merchant terminal is disclosed. The merchant terminal includes a memory comprising stored instructions and at least one processing module in operable communication with the memory. The at least one processing module is configured to execute the stored instructions to cause the merchant terminal to perform the method. The method also includes displaying an approval request on a display screen for receiving an approval from the customer to redeem at least a part of a gift balance amount associated with a gift card of the customer. The approval request is received from the server system in response to detecting the gift card of the merchant already linked with the payment card. The method includes providing a user preference input comprising a redemption amount to the server system. The redemption amount is an amount from the gift balance amount that the customer wants to redeem for the transaction amount. The method further includes receiving a notification comprising a payment transaction approval message of the payment and a redemption of at least the part of the gift balance amount from the gift card.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, in which at least some example embodiments of the present disclosure can be implemented;

FIG. 2 illustrates a sequence flow diagram of linking a gift card of a merchant with a payment card of a customer, in accordance with an example embodiment of the present disclosure;

FIGS. 3A & 3B illustrate a sequence flow diagram of redeeming at least a part of a gift balance amount from the gift card associated with the customer at a merchant terminal, in accordance with an example embodiment of the present disclosure;

FIG. 3C illustrates a sequence flow diagram of redeeming a gift balance amount from the gift card associated with the customer at the merchant terminal, in accordance with an example embodiment of the present disclosure;

FIG. 3D illustrates a sequence flow diagram of redeeming a gift balance amount from the gift card associated with the customer at the merchant terminal, in accordance with another example embodiment of the present disclosure;

FIG. 4 illustrates a simplified representation of a table storing information corresponding to linking of one or more gift cards with a payment card of the customer, in accordance with an example embodiment of the present disclosure;

FIG. 5 illustrates an example representation of a UI displayed to a customer on a display screen of a user device by an application interface for linking a gift card offered by a merchant with a payment card of the user, in accordance with an example embodiment of the present disclosure;

FIG. 6A illustrates an example representation of a UI displayed to a customer on a display screen depicting an approval request to redeem at least a part of a gift balance amount for a transaction amount, in accordance with an example embodiment of the present disclosure;

FIG. 6B illustrates an example representation of a UI displayed to a customer on a display screen depicting an approval request for redeeming at least a part of a gift balance amount (redemption amount) for a transaction amount, in accordance with another example embodiment of the present disclosure;

FIG. 6C illustrates an example representation of a UI displayed to a customer on a display screen depicting an approval request to redeem at least a part of a gift balance amount for a transaction amount, in accordance with another example embodiment of the present disclosure;

FIG. 7A shows an example notification for the customer depicting redemption of at least a part of a gift balance amount, in accordance with an example embodiment of the present disclosure;

FIG. 7B shows an example notification for the customer depicting validity of a gift card linked with a payment card, in accordance with an example embodiment of the present disclosure;

FIG. 8 illustrates a flow diagram depicting a method for redeeming a gift card linked with a payment card of the customer, in accordance with an example embodiment of the present disclosure;

FIG. 9 is a simplified block diagram of a server system for redeeming a gift card at a merchant terminal of a merchant, in accordance with an example embodiment of the present disclosure;

FIG. 10 is a simplified block diagram of a POS terminal of a merchant used for redeeming a gift card offered by a merchant, in accordance with an example embodiment of the present disclosure;

FIG. 11 is a simplified block diagram of an issuer server used for performing payment of at least a part of a transaction amount with a payment card, in accordance with an example embodiment of the present disclosure;

FIG. 12 is a simplified block diagram of an acquirer server used for processing payment transactions and redemption of a gift card offered by a merchant at a merchant terminal, in accordance with an example embodiment of the present disclosure;

FIG. 13 is a simplified block diagram of a payment server used for redeeming at least a part of a gift balance amount from a gift card of a customer at a merchant terminal, in accordance with an example embodiment of the present disclosure; and

FIG. 14 shows simplified block diagram of a user device, for example, a mobile phone capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuer account” used throughout the description refers to a financial account that is used to fund the financial transaction (interchangeably referred to as “payment transaction”). Further, the “acquirer account” used throughout the description refers to a financial account of a merchant or any entity which receives the fund from the issuer account. Examples of the issuer account and the acquirer account include, but are not limited to a savings account, a credit account, a checking account and a virtual payment account. Each of the issuer account and the acquirer account may be associated with an entity such as an individual person, a family, a commercial entity, a company, a corporation, a governmental entity, a non-profit organization and the like. In some scenarios, an issuer or acquirer account may be a virtual or temporary payment account that can be mapped or linked to a primary payment account, such as those accounts managed by a payment wallet.

The term “payment account” used throughout the description refers to a financial account that is used to fund the financial transaction (interchangeably referred to as “payment transaction”). Examples of the payment account include, but are not limited to a savings account, a credit account, a checking account, a digital wallet, and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by payment wallets.

The term “payment card”, used throughout the description, refers to a physical or virtual card linked with a financial or payment account that may be presented to a merchant or any such facility in order to fund a financial transaction via the associated payment account. Examples of the payment card include, but are not limited to, debit cards, credit cards, prepaid cards, digital wallet, gift card, virtual payment numbers, virtual card numbers, forex cards, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account. The transactions performed using the payment cards are referred to as “payment card transactions”, “financial transactions” or simply “payment transaction”. An example of a financial transaction may include making payment using the payment card at a merchant facility using POS terminals.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be operated to perform transactions via cash-substitutes, which may include payment cards, letters of credit, checks, financial accounts, etc. One example of a payment network includes those operated by Mastercard.

The term “gift card” used throughout the description, refers to a physical or virtual card comprising pre-paid stored value corresponding to a gift amount and used as a method of payment for performing transactions. As described herein, the term “gift card” includes cards such as, but not limited to, prepaid cards or loyalty/rewards cards, digital gift cards and mobile gift cards offered for products or service. Virtual gift cards delivered via email or short message service or accessed via an application installed on mobile phones, personal digital assistants (PDAs), and key fobs may fall within the scope of the term “gift cards”. Moreover, the “gift card” of a merchant refers to a gift card offered by the merchant that can be redeemed at the merchant or partners/agents of the merchant in exchange for goods/services. It shall be noted that the terms “gift card” and “merchant gift card” have been used interchangeably throughout the description. The transactions performed using the gift cards are referred to as “financial transactions” or “payment transaction”. An example of a financial transaction may include making payment using the gift card at a business for products/services purchased by the consumer.

The term “merchant” as used hereinafter refers to a merchant facility equipped with electronic payment infrastructure, such as POS terminals for performing financial transactions in exchange for goods/services. An example of the merchant may be physical store such as, a restaurant, a book store, a coffee shop, a saloon and a supermarket or an online store providing facilities of the physical store.

The terms “user”, “customer” or “consumer” have been used interchangeably throughout the description and refer to a person purchasing a product/service using the gift card.

Overview

In many example scenarios, a user may receive one or more gift cards on an occasion, for example, a birthday of the user. The one or more gift cards may be physical or virtual gift cards and the gift cards may be offered by different businesses (or retailers). The physical gift cards have to be carried along with other payment cards and carried around by the user. Although, the virtual gift card spares the user the hassle of carrying around the gift card, limitations arise in both cases of physical and virtual gift cards when the customer has to remember to redeem the gift card while making a purchase at the business. In an example, the customer may receive a gift card for shopping at a business from an acquaintance. However, the customer may pay for the goods/services purchased at the business using cash or a payment card of the customer when he/she fails to remember to redeem the gift card for the purchases made at the business.

Various example embodiments of the present disclosure provide methods, systems, user devices and computer program products for redeeming a gift card at a merchant terminal that overcome above-mentioned obstacles and provide additional advantages. More specifically, techniques disclosed herein enable linking of the gift card with a payment card of the customer for performing payments in exchange for good/services purchased from a business offering the gift card.

In an embodiment, the customer on receipt of a gift card may choose to link the gift card with at least one payment card of the customer (or user). In an example, the customer may have a gift card for a brick and mortar merchant (e.g., a physical retail shop), or for online merchants (e.g., e-commerce retailers), which he may choose to link with a payment card. In an embodiment, a server system associated with a payment network provides a software application, referred to herein as an application interface, in response to a user request received from a user device. The application interface is configured to collect customer information of the customer and register the gift card with at least one payment card of the customer. The user device sends a registration request from the application interface to the server system. The registration request comprises at least a payment card information of the customer, a merchant identifier of the merchant offering the gift card and a gift card identifier associated with the gift card. Optionally, the user can scan identifiers associated with the gift card to identify the merchant identifier, the gift card identifier and the gift amount. The server system is configured to verify the registration request from the user. In at least one example embodiment, the server system is configured to store the merchant identifier, the gift amount associated with the gift card along with existing customer data thereby linking the gift card with the payment card of the customer. For example, the customer may choose to link the gift card offered by a first merchant with a debit card (a primary card) and gift card offered by a second merchant with a credit card (a secondary card) of the customer. The server system sends a notification comprising a successful linking of the merchant gift card with the payment card of the customer. In an embodiment, details related to gift card linked with payment card of the customer are stored in a table at the server system. The server system tracks purchases made using the gift card to determine a gift balance amount of the gift card after transaction performed using the gift card.

In an embodiment, the consumer may purchase goods/services from a merchant and offer to pay for the good/services at the merchant terminal using the payment card of the customer. For example, when the customer shops at Merchant A, the customer may pay at a merchant terminal of the Merchant A using a payment card, for example, the debit card. When the payment card is swiped at the merchant terminal, the merchant terminal sends a payment transaction request to the server system. The payment transaction request includes a merchant information associated with a merchant (the Merchant A), a payment card information of the payment card of the customer and a transaction amount to be paid to a merchant account of the Merchant A from an issuer account of the customer. The merchant information may include a name, a merchant identifier and merchant account details of the merchant (e.g., Merchant A). When the server system receives the payment transaction request, the server system looks up in the table to detect if at least one gift card with a gift balance amount associated with the merchant (e.g., the Merchant A) is already linked with the payment card of the customer. If the server system detects at least one gift card of the merchant (e.g., the Merchant A) linked with the payment card in the table, the server system sends an approval request to the customer for using at least a part of the gift balance amount. The approval request is either displayed on the merchant terminal at the merchant or sent to the user device via the application interface. For example, when the customer swipes his debit card at merchant terminal for performing a payment transaction, the server system detects the gift card with a gift balance amount of $200. The server system sends the approval request and prompts the customer to redeem at least a part of the gift balance amount for the payment of the transaction amount.

The customer may choose to approve or decline the approval request from the server system. The application interface may provision a UI for the customer to provide a user preference input corresponding to a redemption amount that may be redeemed from the gift balance amount. In at least one example embodiment, the server system on detecting the gift card of the merchant with a gift balance amount linked with the payment card of the customer, places a hold on the gift balance amount. The server system determines a balance amount to be retrieved from an issuer account of the customer either based on the redemption amount provided by the customer or the gift balance amount that is held by the server system. The server system places a request for the balance amount from the issuer account and upon successful verification of the request, the balance amount is transferred from the issuer account of the customer to the merchant account of the merchant along with the redemption amount (or gift balance amount) via the payment server. In an embodiment, the server system sends a notification comprising a payment transaction approval message of the payment and redemption of the gift balance amount from the gift card to the customer.

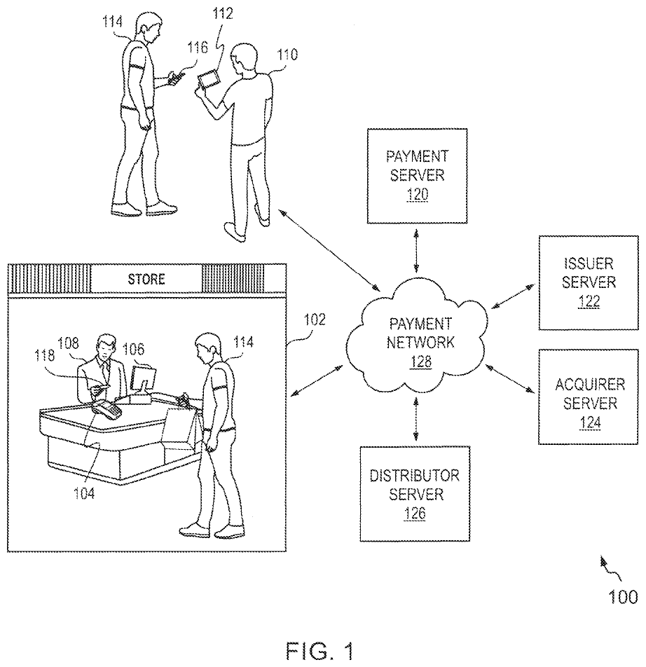

Various example embodiments of methods and systems for redemption of at least a part of the gift balance amount from a gift card linked with the payment card of the customer at a merchant terminal are further explained or suggested in detail with reference to FIGS. 1 to 14.

FIG. 1 illustrates an example representation of an environment 100, in which at least some example embodiments of the present disclosure can be implemented. In the illustrated environment 100, a customer 110 may give a gift card 112 to a friend (referred to as a ‘customer 114’) on an occasion, for example, a work anniversary. The customer 110 may pick the gift card 112 from a rack at any distribution outlet or may purchase the gift card 112 from an online store. The gift card 112 is for the merchant 102 and the gift card 112 may be used to perform a financial transaction in exchange for goods/services availed at the merchant 102. The gift card 112 is activated by a distributor server 126 and the gift amount (funds) is loaded onto the gift card 112 when the customer 110 pays for the gift amount. Additionally, the distributor server 126 is configured to manage the gift card 112, such as, track the activation of the gift card 112 and track the gift balance amount in the gift card 112 after every purchase at the merchant 102.

The environment 100 includes a merchant facility 102 (also referred to herein as ‘a merchant 102’) equipped with a merchant terminal/a POS terminal 104 and a merchant interface device 106. In various embodiments, the merchant interface device 106 can be a telephone or a computer system operated by an agent 108 for performing payment transactions on behalf of a customer. As seen in FIG. 1, the merchant interface device 106 is a computer system operated by the agent 108. It shall be noted that herein the POS terminal 104 (also referred to herein as ‘the merchant terminal 104’) refers to a POS machine which is used to swipe payment cards, and the POS machine is generally equipped or associated with an entire setup including, cash drawers, printers and barcode scanners. Examples of the merchant 102 may include any retail shop, restaurant, supermarket or establishment, such as, government and/or private agencies, or any such place equipped with POS terminals, such as the merchant terminal 104 where customers visit for performing financial transaction in exchange for any goods and/or services or any transaction that requires financial transaction between customers and a merchant.

In conventional scenarios, the customer 114 may have to carry the gift card 112 around and remember to produce the gift card 112 at the POS terminal 104 for redeeming the gift amount on the next purchase at the merchant facility 102. In addition to the hassles of carrying the gift card 112 around, the customer 114 must remember to redeem the gift card 112 before expiry of the gift amount in the gift card 112. In such cases, the customer 114 may choose to link his/her gift card 112 with a payment card 118 of the customer 114. It shall be noted that the terms, “issuer bank” or “issuing bank” or simply “issuer”, indicate a bank in which the customer 114 may have a financial account and the issuing bank issues a payment card, such as a credit card or a debit card, to the customer 114. Alternatively, the customer 114 can link the gift card 112 with a digital wallet of the customer 114. The customer 114 may have one or more mobile devices, for example, the customer 114 has a user device 116. Examples of the user device 116 are not limited to mobile phones only, and the user device 116 may take examples of any portable electronic device (e.g., laptops, smartphones and tablets) having communication capabilities.

In one embodiment, a payment server 120 provides a software application, referred to herein as an application interface, in response to a user request from the user device 116. The application interface is a digital user interface for the customer 114 for registration and redemption of the gift card 112. Accordingly, the application interface is configured to collect customer information of the customer 114 and register the gift card 112 with at least one payment card, for example, the payment card 118 of the customer 114. In at least one example embodiment, the application interface sends a registration request to the payment server 120. The registration request comprises at least a payment card information of the customer 114, a merchant identifier of the merchant 102 offering the gift card 112 and a gift card identifier associated with the gift card 112. Optionally, the customer 114 can scan an identifier associated with the gift card 112 to identify the merchant identifier, the gift card identifier and the gift amount of the gift card 112. The payment server 120 is configured to verify the registration request from the customer 114. For example, the payment server 120 may authenticate the customer 114 prior to linking the gift card 112 with the payment card 118 using one or more authentication techniques such as, a security question, One Time Password (OTP), mobile number verification or biometric access. In at least one example embodiment, the payment server 120 is configured to store the merchant identifier, the gift amount associated with the gift card along with existing customer data thereby linking the gift card 112 with the payment card 118 of the customer 114. For example, the customer 114 may choose to link gift cards offered by a first merchant (M1) and a second merchant (M2) with a debit card (a primary card) and a gift card offered by a third merchant (M3) with a credit card (a secondary card). The application interface may provision one or more UIs to collect details associated with the gift card 112 (e.g., gift cards offered by merchants M1, M2, M3) and the payment card 118 (e.g., the primary card and the secondary card) of the customer 114.

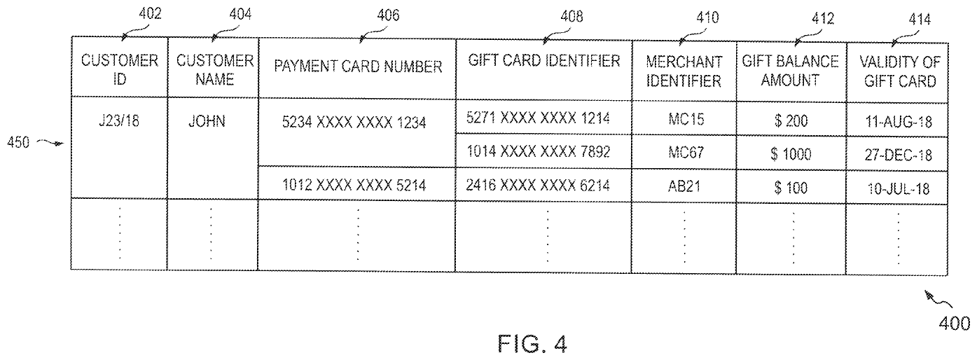

The payment server 120 sends a notification comprising a successful linking of the gift card 112 with the payment card 118 to the customer 114 via the application interface. Accordingly, details related to gift cards linked with the payment card 118 of the customer 114 are stored in a table (see, table 400 at FIG. 4) of the payment server 120. For example, payment card details of the debit card and gift card details of the gift cards, such as, gift amount, gift balance amount, gift card identifier, merchant identifier offered by the first merchant (M1) and the second merchant (M2), which are integrated with the debit card, are stored in the table against existing customer data. In some embodiments, the gift card 112 may be linked with a digital wallet of the customer 114. In such cases, the gift card 112 is automatically linked with the primary card of the digital wallet, for example, the debit card of the customer 114.

In at least one example embodiment, the payment server 120 tracks purchases made using the gift card 112 to determine a gift balance amount of the gift card 112 after a transaction is performed using the gift card 112 at the merchant 102. Alternatively, the distributor server 126 tracks the gift balance amount of the gift card 112 after every purchase and updates the same in the table of the payment server 120.

When the customer 114 visits the merchant 102 for a purchase, the customer 114 unaware of the presence of the gift card 112 for the merchant 102 may offer to pay for the products using the payment card 118. As can be seen from the environment 100, the customer 114 is making the financial transaction at the POS terminal 104. It shall be noted that more than one such POS terminal can be present at the merchant facility 102. In conventional scenarios, the customer 114 would reach the POS terminal 104 upon his turn and present the payment card 118 to the agent 108 managing the POS terminal 104. Thereafter, the agent 108 swipes the payment card 118 of the customer 114, and performs an authentication of the payment card 118 for checking of credit or debit balance.

A payment transaction request is initiated at the POS terminal 104 for a purchase of goods made by the customer 114 at the merchant facility 102. The payment transaction request comprises a first information associated with the merchant 102, second information associated with the payment card 118 of the customer 114 and a transaction amount to be paid to a merchant account of the merchant 102 from an issuer account of the customer 114. Examples of the first information include, among other things, a name, a merchant identifier and merchant account details of the merchant 102, and “first information” is also interchangeably used as “merchant information” throughout the present disclosure. Examples of the second information include, among other things, issuer detail, payment card number, name of the customer 114, Card Verification Value (CVV) and a validity date of the payment card, and the “second information” is also interchangeably used as “payment card information” throughout the present disclosure

When a server system such as the payment server 120 receives the payment transaction request, the payment server 120 looks up in the table to detect if at least one gift card with a gift balance amount associated with the merchant 102 is already linked with the payment card 118 of the customer 114. If the payment server 120 detects at least one gift card of the merchant 102, for example, the gift card 112 linked with the payment card 118, the payment server 120 sends an approval request to the customer 114 for using at least a part of the gift balance amount. The approval request is either displayed on the merchant terminal 104 at the merchant 102 or sent to the user device 116 via the application interface. For example, when the customer 114 swipes his debit card (the payment card 118) at the first merchant (M1) for performing a payment transaction, the payment server 120 detects the gift card 112 offered by the first merchant (M1) with a gift balance amount of $200 linked with the debit card (e.g., card 118) of the customer 114. The payment server 120 sends the approval request to the customer 114 and prompts the customer 114 to redeem at least a part of the gift balance amount for the payment of the transaction amount.

The application interface may provision a UI for the customer 114 to provide a user preference input corresponding to a redemption amount that may be redeemed from the gift balance amount ($200). The customer 114 can choose to redeem the entire amount or at least a part of the amount (e.g., $50) for the payment at the merchant 102. In at least one example embodiment, the payment server 120 on detecting the gift card 112 of the merchant 102 with a gift balance amount linked with the payment card 118 of the customer 114, places a hold on the gift balance amount.

The payment server 120 determines a balance amount to be retrieved from an issuer account of the customer 114 either based on the redemption amount provided by the customer 114 or the gift balance amount that is held by the payment server 120. For example, the customer had made a purchase for $250 at the first merchant (M1) and the gift card 112 (offered by the first merchant) has a gift balance amount of $200. In one embodiment, the payment server 120 holds the gift balance amount of $200 and determines a balance amount of $50 that has to be deducted from an issuer account associated with the debit card (the payment card 118). In another embodiment, the customer may choose to redeem $100 (redemption amount as indicated by the user preference input) from the gift balance amount of $200. Accordingly, the payment server 120 determines the balance amount to be deducted from the issuer account as $150.

In at least one example embodiment, the payment server 120 places a request for the balance amount to an issuer server 122 for deducting the balance amount from the issuer account. To accept payment transactions from customers, the merchant 102 must normally establish an account with a financial institution that is part of the financial payment system. This financial institution is usually called the “merchant bank” or the “acquiring bank” or simply “acquirer”. The acquirer of the merchant 102 is referred to as an acquirer and a server processing the payment transaction to the merchant account is called an acquirer server 124. The issuer server 122 verifies the request and simultaneously or subsequently, the issuer server 122 debits funds equal in amount to the balance amount from the issuer account of the customer 114. The payment comprising the balance amount and the gift balance amount/redemption amount is passed to the merchant account of the merchant 102 to complete the payment transaction via the payment server 120.

In an embodiment, the payment server 120 sends a notification comprising a payment transaction approval message (e.g., a message indicating approval of the payment transaction) of the payment and redemption of the gift balance amount from the gift card 112 to the customer 114 via a payment network 128.

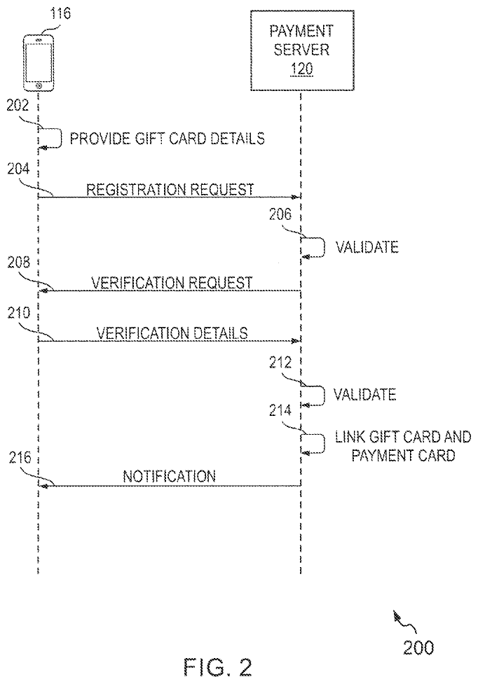

Some non-exhaustive example embodiments of redeeming a gift card at the merchant terminal 104 are described with reference to FIGS. 2 to 14.

FIG. 2 illustrates a sequence flow diagram 200 of linking a gift card of a merchant with a payment card of a customer, in accordance with an example embodiment of the present disclosure.

At 202, the customer 114 accesses an application interface in the user device 116 for providing customer information and gift card details. In an example embodiment, the application interface may be managed by the payment server 120, or any entity associated with the payment server 120. The customer 114 may log in to a user account of the customer 114 in the application interface by providing the customer information. The customer 114 may provide the second information i.e. the payment card information such as, payment card number, name of the customer 114, Card Verification Value (CVV) and a validity date of the payment card 118. Further, the customer 114 provides gift card details such as, gift card identifier, name of the merchant who offered the gift card 112 and a gift amount of the gift card 112. The application interface is configured to aid the customer 114 for registration of the gift card 112 with at least one payment card 118 (e.g., the debit card) of the customer 114. Optionally, the customer 114 can scan an identifier associated with the gift card 112 to identify a merchant identifier of the merchant 102, name of the merchant 102, the gift card identifier and the gift amount.

At 204, the application interface sends a registration request to the payment server 120. The registration request is initiated by the customer 114 for linking the payment card 118 with the gift card 112 thereby ensuring that the customer 114 is spared the hassle of carrying the gift card 112 and remembering to redeem it at the merchant 102. The registration request comprises at least the payment card information of the customer 114, a merchant identifier of the merchant 102 offering the gift card 112 and the gift card identifier associated with the gift card 112.

At 206, the registration request is validated by the payment server 120.

At 208, the payment server 120 sends a verification request to the customer 114 on the user device 116. The verification request may be received on the application interface and provides an additional layer of security for the customer 114 who intends to link the gift card 112 and the payment card 118. In a non-limiting example, the verification request may comprise a security question, a PIN request, a fixed character length One Time Password (OTP) on registered user device or request for biometric data of the customer 114.

At 210, the customer 114 may provide verification details based on the verification request to the payment server 120. For instance, in a non-limiting example, the customer 114 may provide a fixed length character, a correct fixed character length PIN or a fixed character length OTP, or biometric identity such as fingerprint, voice sample, iris scan for verifying the identity of the customer 114.

At 212, the verification details of the customer 114 are validated and authenticated by the payment server 120.

At 214, the payment server 120 links the gift card 112 with the payment card 118 of the customer 114. For example, the payment server 120 creates an entry in a table and associates the gift card identifier of the gift card 112 with the payment card 118 of the customer 114 and stores details of the linking. The entry in the table will include details such as, customer identifier, customer name, payment card number, gift card identifier of the gift card 112 linked with the payment card 118, merchant identifier of the merchant 102, gift balance amount of the gift card 112 and validity of the gift card 112.

At 216, the payment server 120 sends a notification comprising a successful linking of the gift card 112 with the payment card 118 to the customer 114. The notification may be displayed on the application interface installed on the user device 116 therein.

It shall be noted that the customer 114 has the freedom to link as many gift cards as possible with a payment card of the customer 114 by performing the sequence of steps stated above.

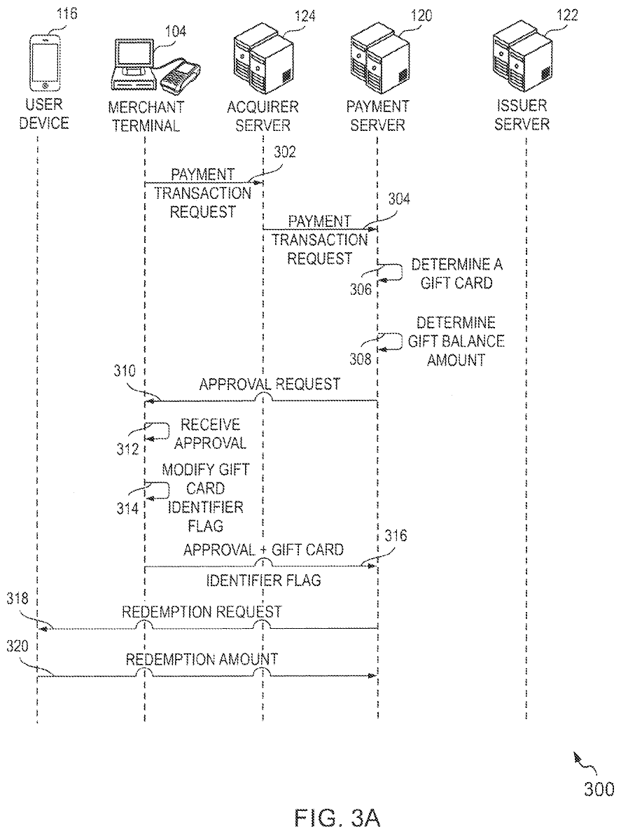

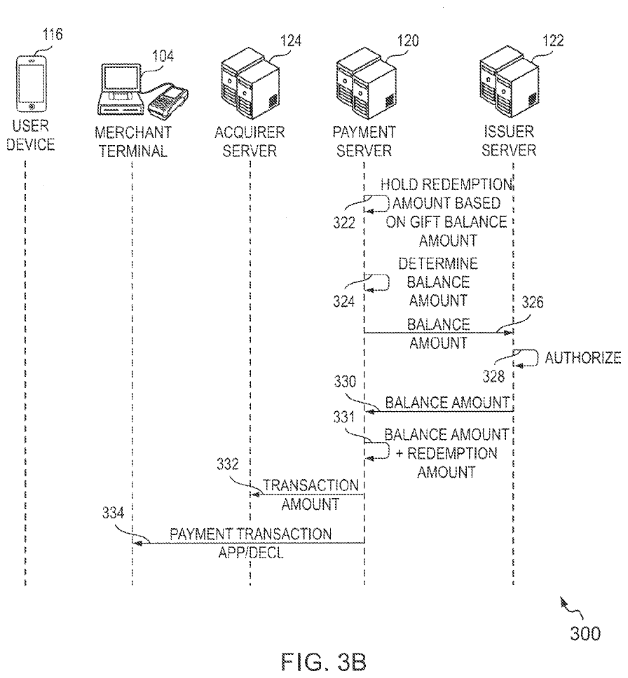

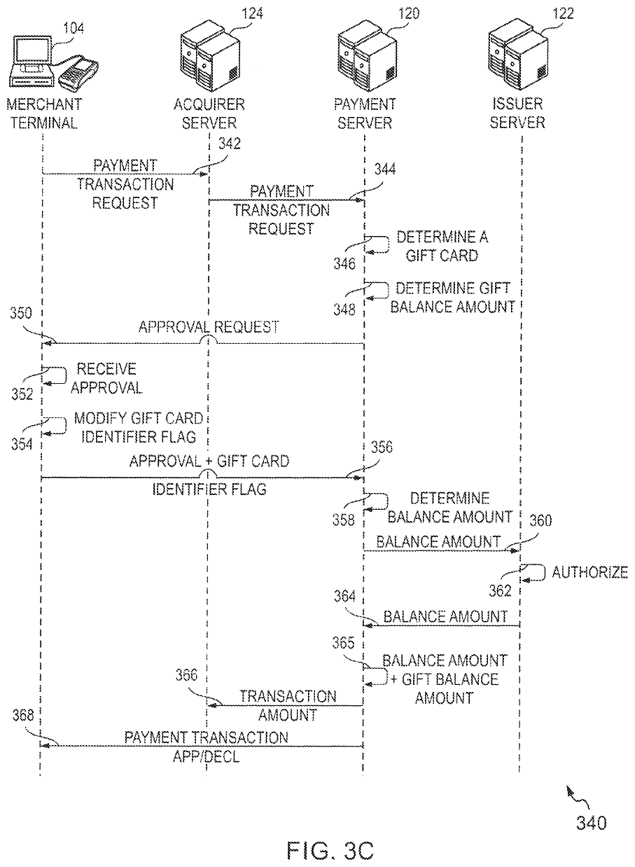

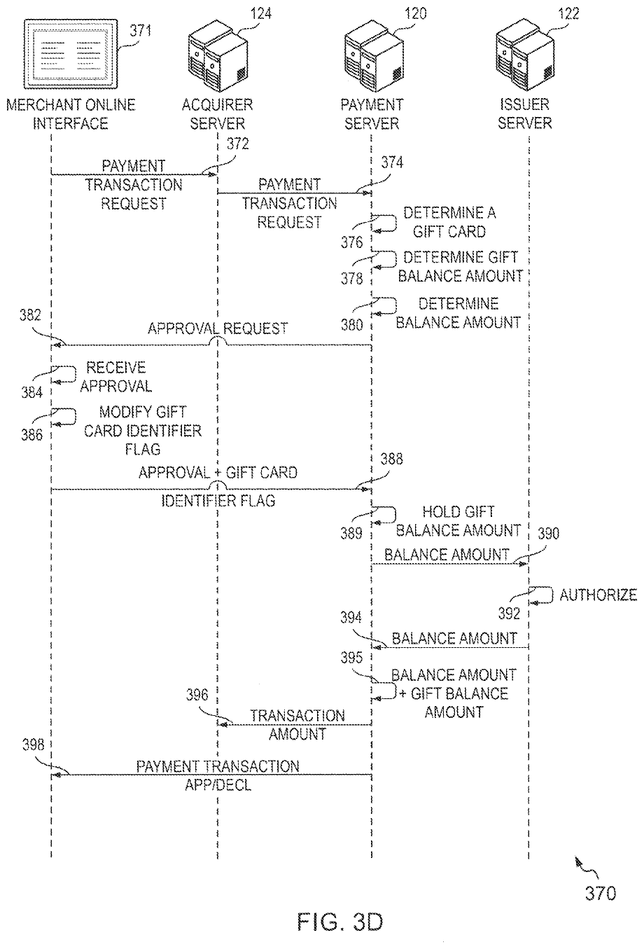

Referring now to FIGS. 3A-3B, a sequence flow diagram 300 of redeeming at least a part of a gift balance amount from the gift card 112 associated with the customer 114 at the merchant terminal 104 is illustrated in accordance with an example embodiment of the present disclosure. The customer 114 purchases goods/services from the merchant 102 and offers to perform payment for the goods using the payment card 118 provided by an issuer. The agent 108 swipes the payment card 118 at the merchant terminal 104 of the merchant 102.

At 302, the merchant terminal 104 sends a payment transaction request to the acquirer server 124. The payment transaction request comprises a merchant information associated with the merchant 102, a payment card information of the payment card 118 of the customer 114 and a transaction amount to be paid to a merchant account from an issuer account of the customer 114. The merchant information may include a name, a merchant identifier and merchant account details of the merchant 102. It shall be noted that the merchant terminal 104 scan/reads customer data stored in the payment card 118 to identify the issuer account. The agent 108 may key-in the transaction amount on the merchant terminal 104 and the merchant information is accessed from the merchant terminal 104. In an embodiment, if the payment transaction is initiated at an online merchant site where example of the merchant terminal 104 is an online payment interface of the merchant 102, the customer 114 may key-in the payment card information of the customer 114. In some cases, the customer data may be in form of an identifier, for example, a QR code that may be scanned at the merchant terminal 104.

At 304, the acquirer server 124 forwards the payment transaction request to the payment server 120.

At 306, the payment server 120 determines if the payment card 118 is linked to any gift card associated with the merchant 102. For example, the payment server 120 may use the merchant identifier to look up into a table (see, table 400 in FIG. 4) at the payment server 120 for identifying if the payment card 118 is linked with any gift card offered by the merchant 102 associated with the merchant identifier. If the payment server 120 detects at least one gift card, for example, the gift card 112 of the merchant 102, the payment server 120 retrieves details of the gift card 112 from the table. It shall be noted that the customer 114 may have linked one or more gift cards offered by the merchant 102 with the payment card 118 of the customer 114. In such cases, the payment server 120 detects the one or more gift cards of the merchant 102 linked with the payment card 118 in the table.

At 308, the payment server 120 determines a gift balance amount of the gift card 112 detected in the table. In one embodiment, the payment server 120 keeps track of the financial transactions performed using the gift card 112 to determine a gift balance amount associated with the gift card 112. The payment server 120 combs through the gift cards to identify one or more gift cards which have a gift balance amount. It shall be noted that if a gift card (e.g., the gift card 112) has no gift balance amount (i.e. $0 balance), the gift card 112 does not show up in the table. Moreover, if there are more than one gift cards associated with a gift balance amount greater than $0 balance, the payment server 120 determines a total gift balance amount in the one or more gift cards.

At 310, the payment server 120 sends an approval request to the customer 114 for redeeming at least a part of the gift balance amount of the gift card 112 at the merchant 102 for the transaction amount. The approval request is displayed on a display screen of the merchant terminal 104 at the merchant 102. For example, when the customer swipes his debit card at the third merchant (M3) for performing a payment transaction, the payment server 120 detects the gift card 112 (offered by the third merchant) and prompts the customer 114 to provide consent for redeeming the gift card 112 at the merchant 102. In at least one example embodiment, the approval request is received on the user device 116 via the application interface.

At 312, the customer 114 may choose to approve or decline the approval request sent by the payment server 120.

At 314, upon receiving an approval of the customer 114 for redeeming at least a part of the gift balance amount, a gift card identifier flag is modified in the merchant terminal 104. The gift card identifier flag indicates if the payment server 120 has to deduct the transaction amount entirely from an issuer account of the customer 114. When the customer 114 provides an approval for redeeming at least a part of the gift amount, the merchant terminal 104 automatically sets the gift card identifier flag such that the payment server 120 understands that at least a part of the transaction amount is retrieved from the gift card 112.

At 316, the merchant terminal 104 sends the approval of the customer 114 along with the gift card identifier flag to the payment server 120.

At 318, the payment server 120 sends a redemption request to the user device 116 upon receiving the approval. In an embodiment, the application interface may display at least one UI requesting the customer 114 to provide a redemption amount from the gift balance amount of the gift card 112.

At 320, the customer 114 provides a user preference input on the at least one UI indicating the redemption amount that can be redeemed from the gift balance amount of the gift card 112. The redemption amount provided by the customer 114 on the user device 116 is sent to the payment server 120. For example, if the gift card 112 for a merchant (e.g., the first merchant) is associated with a gift balance amount of $100, the customer 114 may choose to redeem entire $100 or $50 against a bill of $200 (the transaction amount).

At 322, the payment server 120 holds the redemption amount from the gift balance amount based on the user preference input received from the customer 114.

At 324, the payment server 120 determines a balance amount based on the redemption amount provided by the customer 114. For example, if the customer 114 chooses to redeem $100 against the bill (transaction amount) of $200 at the first merchant, the balance amount is $100 that has to be deducted from an issuer account associated with the payment card 118 of the customer 114.

At 326, the payment server 120 sends a transaction request for the balance amount to the issuer server 122.

At 328, the issuer server 122 authorizes the payment card information of the customer 114 and approves the transaction request. For instance, in a non-limiting example, upon receiving a correct fixed character length PIN or a fixed character length one time password (OTP) from the customer 114, the customer 114 is validated and authenticated by the issuer server 122 and the balance amount is provided to the payment server 120.

At 330, the payment server 120 receives the balance amount debited from the issuer account of the customer 114 based on the payment card details (e.g., the payment card 118)

At 331, the payment server 120 aggregates the balance amount and at least the part of the gift balance amount (or the redemption amount) held by the payment server 120.

At 332, the payment server 120 settles the transaction amount to the merchant account of the merchant 102 via the acquirer server 124. Details of the payment transaction from the issuer account to the merchant account are not provided herein in detail for the sake of brevity.

At 334, the payment server 120 sends a notification including a payment transaction approval or decline message to the merchant terminal 104. Optionally, the notification including the payment transaction approval or decline message is also sent to the acquirer server 124 via the payment network 128.

Referring now to FIG. 3C, a sequence flow diagram 340 of redeeming a gift balance amount from the gift card 112 associated with the customer 114 at the merchant terminal 104 is illustrated in accordance with another example embodiment of the present disclosure. The customer 114 purchases goods/services from the merchant 102 and offers to perform payment for the goods using the payment card 118 provided by an issuer such as associated with the issuer sever 122. The agent 108 swipes the payment card 118 at the merchant terminal 104 of the merchant 102.

At 342, the merchant terminal 104 sends a payment transaction request to the acquirer server 124. The payment transaction request comprises a merchant information associated with the merchant 102, a payment card information of the payment card 118 of the customer 114 and a transaction amount to be paid to a merchant account from an issuer account of the customer 114. The merchant information may include a name, a merchant identifier and merchant account details of the merchant 102. It shall be noted that the merchant terminal 104 scan/reads customer data stored in the payment card 118 to identify the issuer account. The agent 108 may key-in the transaction amount on the merchant terminal 104 and the merchant information is accessed from the merchant terminal 104.

At 344, the acquirer server 124 forwards the payment transaction request to the payment server 120.

At 346, the payment server 120 determines if the payment card 118 is linked to any gift card associated with the merchant 102. For example, the payment server 120 may use the merchant identifier to look up into a table at the payment server 120 for identifying if the payment card 118 is linked with any gift card offered by the merchant 102 associated with the merchant identifier.

At 348, the payment server 120 determines a gift balance amount of the gift card 112 detected in the table. In one embodiment, the payment server 120 keeps track of the financial transactions performed using the gift card 112 to determine a gift balance amount associated with the gift card 112. It shall be noted that steps 342-348 have been explained with reference to FIGS. 3A-3B and are not provided herein in detail for the sake of brevity.

At 350, the payment server 120 sends an approval request to the customer 114 for redeeming the gift balance amount of the gift card 112 at the merchant 102 for the transaction amount. In at least one example embodiment, the approval request is displayed on a display screen of the merchant terminal 104 at the merchant 102. For example, when the customer shops at the third merchant (M2) and swipes his credit card for performing a payment transaction, the payment server 120 detects the gift card 112 (offered by the third merchant linked with the credit card). The merchant terminal 104 may display a notification on the display screen and prompt the customer 114 to provide a consent for redeeming the gift balance amount in the gift card 112 at the merchant 102. Alternatively or additionally, payment server 120 can send the approval request directly on the user device 116, where the request is displayed via the application interface upon its receipt.

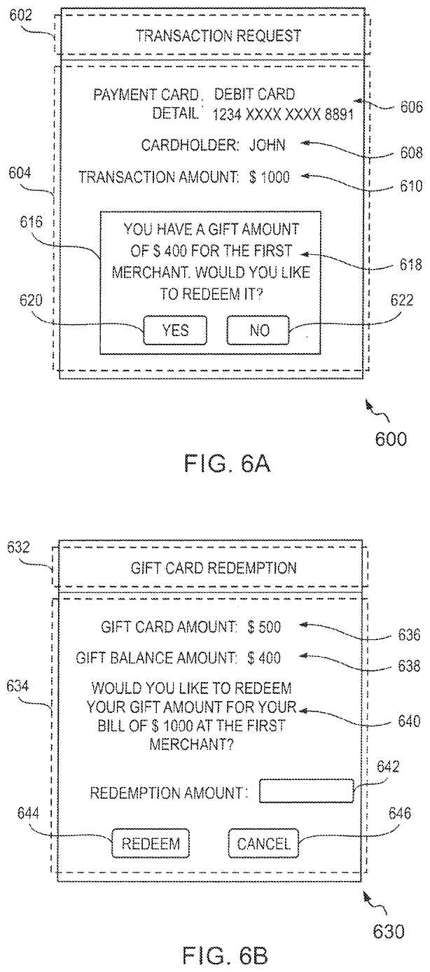

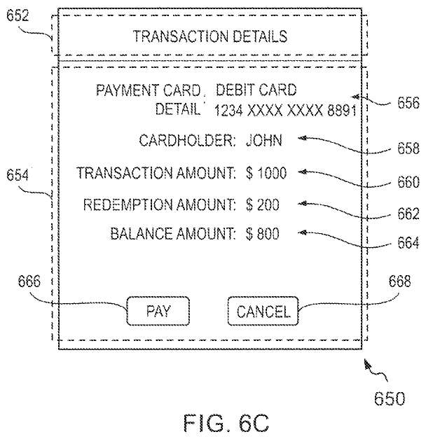

At 352, the customer 114 may choose to approve or decline the approval request sent by the payment server 120. The approval/decline for the approval request may be in form of a touch input or a selection input on a corresponding option displayed on the display screen of the merchant terminal 104. In an embodiment, if the customer 114 provides an approval for the approval request sent on the user device 116, the payment server 120 automatically updates the merchant terminal 104 of the customer 114 consent to redeem the gift balance amount from the gift card 112. In an example scenario, the customer 114 may choose to redeem the gift balance amount in the gift card 112 during a purchase at a later point of time and hence can decline the approval request. In such cases, the transaction amount is settled between the issuer account of the customer 114 and the merchant account of the merchant 102 using only the payment card 118. An example UI depicting an approval request sent to the customer 114 is shown and explained with reference to FIG. 6A.

At 354, upon receiving an approval of the customer 114 for redeeming the gift balance amount, a gift card identifier flag is modified in the merchant terminal 104. The gift card identifier flag indicates to the payment server 120 if the transaction amount has to be deducted entirely from an issuer account of the customer 114. When the customer 114 provides an approval for redeeming the gift balance amount, the merchant terminal 104 automatically sets the gift card identifier flag such that the payment server 120 understands that at least a part of the transaction amount is retrieved from the gift balance amount in the gift card 112.

At 356, the merchant terminal 104 sends the approval of the customer 114 along with the gift card identifier flag to the payment server 120.

At 358, the payment server 120 determines a balance amount based on the gift balance amount in the gift card 112. In an example, if the customer 114 has a gift balance amount of $300 in the gift card 112 for the third merchant (M3) and if the bill (transaction amount) amounts to $500, the balance amount would be $200 (balance amount=transaction amount−gift balance amount) that will be deducted from the issuer account of the customer 114. Alternatively, if the bill (transaction amount) amounts to $200 and if the customer 114 approves the approval request, then a gift balance amount of $200 is deducted from the gift card 112 and thereafter no balance amount has to be deducted from the issuer account of the customer 114. In an embodiment, the payment server 120 tracks and updates the gift balance amount in the table of the payment server 120. The table is explained in detail with reference to FIG. 4.

At 360, the payment server 120 sends a transaction request for the balance amount to the issuer server 122. As explained above, if there is a balance amount to be deducted from the issuer account of the customer 114, the payment server 120 sends the transaction request. Its shall be noted that sending of the transaction request for the balance amount may be precluded if the gift balance amount is greater than or equal to the transaction amount and there is no processing of balance amount between the issuer account and the merchant account. In such cases, the gift balance amount is sufficient to pay for the good/services purchased by the customer 114 as indicated by the transaction amount, and the payment server 120 settles the transaction amount only using the gift balance amount of the gift card 112.

At 362, the issuer server 122 authorizes the payment card information of the customer 114 and approves the transaction request. The issuer server 122 employs one or more authorization techniques as explained at step 328 (see, FIG. 3A).

At 364, the issuer server 122 sends the balance amount debited from the issuer account of the customer 114 to the payment server 120.

At 365, the payment server 120 consolidates the balance amount and the gift balance amount held by the payment server 120.

At 366, the payment server 120 settles the transaction amount to the merchant account of the merchant 102 via the acquirer server 124 and thereby completing the transaction between the issuer account and the acquirer account of the merchant 102.

At 368, the payment server 120 sends a notification including a payment transaction approval or decline message to the merchant terminal 104. Optionally, the notification including the payment transaction approval or decline message is also sent to the acquirer server 124 via the payment network 128.

In some embodiments, the payment server 120 is configured to prompt the customer to use the gift balance amount of a gift card when the customer is making an online transaction at an online interface of a merchant, which is described with reference to FIG. 3D.

Referring now to FIG. 3D, a sequence flow diagram 370 of redeeming a gift balance amount from the gift card 112 associated with the customer 114 at the merchant terminal is illustrated in accordance with another example embodiment of the present disclosure. In this illustrated embodiment, the merchant terminal is an example of a merchant online interface 371 provided by a merchant or acquirer of the merchant. The customer 114 purchases goods/services from the merchant 102 and swipes the payment card 118 at the merchant online interface 371 of the merchant 102 to pay for the goods/services.

At 372, the merchant online interface 371 sends a payment transaction request to the acquirer server 124. The payment transaction request comprises a merchant information associated with the merchant 102, a payment card information of the payment card 118 of the customer 114 and a transaction amount to be paid to a merchant account from an issuer account of the customer 114. The merchant information may include a name, a merchant identifier and merchant account details of the merchant 102.

At 374, the acquirer server 124 forwards the payment transaction request to the payment server 120.

At 376, the payment server 120 determines if the payment card 118 is linked to any gift card associated with the merchant 102.

At 378, the payment server 120 determines a gift balance amount of the gift card 112 from the table.

At 380, the payment server 120 determines a balance amount based on the gift balance amount in the gift card 112. It shall be noted that steps 372-380 have been explained with reference to FIGS. 3A-3B and are not provided herein in detail for the sake of brevity.

At 382, the payment server 120 sends an approval request to the customer 114 for redeeming the gift balance amount of the gift card 112 at the merchant 102 for the transaction amount. In an example, the approval request indicates the transaction amount to be paid for the goods/services, redeemable gift balance amount in the gift card 112 and the balance amount (if any) to be debited from the issuer account of the customer 114. An example of such an approval request is explained with reference to FIG. 6C.

At 384, the customer 114 may choose to approve or decline the approval request sent by the payment server 120.

At 386, upon receiving an approval of the customer 114 for redeeming the gift balance amount, a gift card identifier flag is modified in the merchant online interface 371.

At 388, the merchant online interface 371 sends the approval of the customer 114 along with the gift card identifier flag to the payment server 120.

At 389, the payment server 120 holds at least a part of the gift balance amount for the transaction amount.

At 390, the payment server 120 sends a transaction request for the balance amount to the issuer server 122.

At 392, the issuer server 122 authorizes the payment card information of the customer 114 and approves the transaction request.

At 394, the issuer server 122 debits the balance amount from the issuer account of the customer 114 and sends the balance amount to the payment server 120.

At 395, the payment server 120 consolidates the balance amount and the gift balance amount held by the payment server 120.

At 396, the payment server 120 settles the transaction amount for the merchant account of the merchant 102 via the acquirer server 124.

At 398, the payment server 120 sends a notification including a payment transaction approval or decline message to the merchant online interface 371. Optionally, the notification including the payment transaction approval or decline message is also sent to the acquirer server 124 via the payment network 128. It shall be noted that steps 384-398 have been explained with reference to FIG. 3C and are not provided herein in detail for the sake of brevity.

Referring now to FIG. 4, a simplified representation of a table 400 maintained at the payment server 120 for storing information corresponding to linking of one or more gift cards with a payment card of the customer 114, is illustrated in accordance with an example embodiment of the present disclosure. As seen in FIG. 4, the table 400 includes listings of a customer identifier (ID), an associated customer name, one or more associated payment cards, one or more gift card identifiers of gift cards linked with each payment card, a merchant identifier associated with each gift card, a redeemable gift balance amount associated with each gift card and a validity associated with each gift card. It shall be noted that the table 400 shown in FIG. 4 is exemplary and only provided for the purposes of explanation. In practical, the table 400 may include multiple such tables and each table may have more or less columns and rows than depicted in FIG. 4.

The table 400 includes columns representing a customer ID field 402, a customer name field 404, a payment card number field 406, a gift card identifier field 408, a merchant identifier field 410, a gift balance amount field 412 and a validity of gift card field 414. The table 400 may include as many rows as number of payment cards available with the customer 114. A row 450 under a column (i.e. the payment card number field 406) is divided into a plurality of sub rows that includes a plurality of payment cards (e.g., the payment card 118) that may have one or more gift cards linked with each payment card. Moreover, the row 450 under a column (i.e. the gift card identifier field 408) is divided into a plurality of sub rows that include a plurality of gift cards (represented by gift card identifiers) such that at least a subset of gift cards (such as the gift card 112) are linked/associated with one payment card. As an example, the row 450 depicts that for a customer (‘John’) with the customer ID “J23/18”, one of the associated payment card is “5234 XXXX XXXX 1234”. The payment card (5234 XXXX XXXX 1234) is linked with two gift cards (gift card 1 and gift card 2) associated with gift cards identifiers “5271 XXXX XXXX 1214” and “1014 XXXX XXXX 7892”. The gift card 1 has a gift balance amount of $200 for a merchant associated with merchant identifier MC #15 and the gift card 2 has a gift balance amount of $1000 to a merchant associated with merchant identifier MC #67. The validity of gift card 1 (gift card identifier “5271 XXXX XXXX 1214”) linked with the payment card (5234 XXXX XXXX 1234) is 11 Aug. 2018 and that of gift card 2 (gift card identifier “1014 XXXX XXXX 7892”) is 27 Dec. 2018.

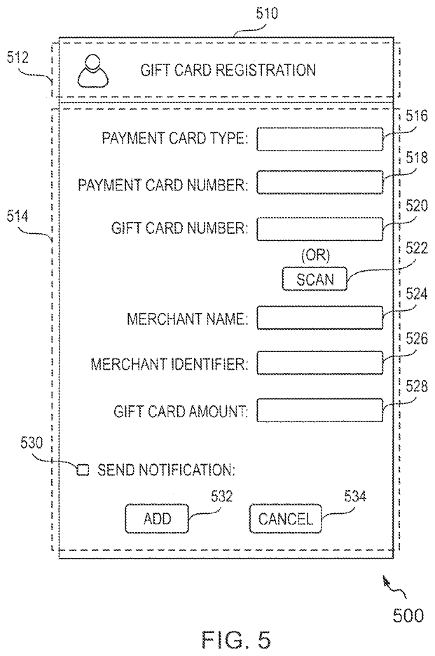

In an embodiment, the application interface causes display of one or more user interfaces (UIs) for receiving customer input related to gift card and payment card information of the customer 114 for (1) linking the gift card with the payment card of the customer 114, and (2) redeeming at least a part of the gift balance amount towards payment of the transaction amount. An example UI displayed to the customer 114 in the user device 116 for provisioning the payment card information and gift card details is shown in FIG. 5.

Referring now to FIG. 5, an example representation of a UI 510 displayed to the customer 114 on a display screen of the user device 116 by an application interface 500 for linking the gift card 112 offered by the merchant 102 with the payment card 118 of the customer 114, is illustrated in accordance with an example embodiment of the present disclosure. In an example scenario, after downloading of the application interface 500 from the payment server 120 (shown in FIG. 1), an application icon (not shown) may be displayed to the customer 114 on the display screen of the user device 116. The customer 114 may provide a selection input on the application icon to invoke the application interface 500. The application interface 500, after invoking, may present one or more UIs for creating an account of the customer 114.

The application interface 500 may also provide an option associated with a label ‘GIFT CARD REGISTRATION’ to provide gift card information and payment card information for linking of the payment card of the customer with the gift card of the customer 114. The UI 510 may be displayed to the customer 114 upon selection of the option associated with the label ‘GIFT CARD REGISTRATION’. It is noted that the provisioning of the ‘GIFT CARD REGISTRATION’ option is explained herein for illustration purposes, and it can be displayed or presented in variety of other ways. Indeed, the UI 510 may be displayed to the customer 114, either directly upon invoking the application interface 500 or by selection of other options or options with different labels than the labels explained herein.

The UI 510 is depicted to include a header portion 512 and a content portion 514. The header portion 512 is depicted to exemplarily display a title associated with text ‘GIFT CARD REGISTRATION’. The content portion 514 of the UI 510 is depicted to display fields such as payment card type (shown as ‘PAYMENT CARD TYPE’), a payment card identifier of the customer (shown as ‘PAYMENT CARD NUMBER’) and a gift card identifier (shown as ‘GIFT CARD NUMBER’). Each field from among the fields is depicted to be associated with a text box. For example, the field ‘PAYMENT CARD TYPE’ is associated with a text box 516, the field ‘PAYMENT CARD NUMBER’ is associated with a text box 518 and the field ‘GIFT CARD NUMBER’ is associated with the text box 520.

The customer 114 may provide a type of the payment card in the text box 516. In an example, the text box 516 may also be a drop down menu displaying a list of payment card types. The payment card can be any of a credit card, a debit card, a digital wallet and the like. A number or identifier (e.g., the payment card number of a debit card) of the payment card is provided by the customer 114 in the text box 518. The identifier of the payment card may be fixed-length numerical identifier or virtual payment card numbers may be of fixed-length character of any combination of alphabets, numbers and special characters. The gift card identifier may correspond to a fixed-length character printed on a physical gift card or an electronic card and may be provided in the text box 520 by the customer 114.

The content portion 514 of the UI 510 is further configured to depict a tab 522 associated with text ‘SCAN’. The customer 114 may provide a touch or a click input on the tab 522 to scan an identifier, for example, a QR or bar code of the gift card 112 for identifying gift card information such as, gift card identifier, merchant name, a merchant identifier and gift amount. The selection of the tab 522 may cause display of another UI for capturing the identifier of the gift card 112 of the customer 114.

The content portion 514 of the UI 510 is depicted to display fields such as name of a merchant (shown as ‘MERCHANT NAME’), a merchant identifier of the merchant (shown as ‘MERCHANT IDENTIFIER’) and a gift amount (shown as ‘GIFT CARD AMOUNT’). Each field from among the fields is depicted to be associated with a text box. For example, the field ‘MERCHANT NAME’ is associated with a text box 524, the field ‘MERCHANT IDENTIFIER’ is associated with a text box 526 and the field ‘GIFT CARD AMOUNT’ is associated with the text box 528.

The customer 114 may provide a name of the merchant (e.g., the merchant 102) in the text box 524. A number or identifier (e.g., MC #15) of the merchant is provided by the customer 114 in the text box 526 and gift amount (e.g., $200) in the gift card is provided in the text box 528. In an example embodiment, when the customer scans the gift card identifier using the tab 522, data corresponding to the text box 524, 526 and 528 are identified from the identifier and automatically filled. It is noted that the fields are shown herein for illustration purpose and that the UI 510 may include more of fewer fields than those depicted in the content portion 514.

The content portion 514 of the UI 510 is further configured to depict an option 530 associated with text ‘SEND NOTIFICATION’. The customer 114 may check on the option to receive text updates of activities performed using the gift card. It shall be noted that the notifications may be sent to a mobile number or e-mail account provided by the customer 114 as a contact. The content portion 514 of the UI 510 is further configured to depict a tab 532 associated with text ‘ADD’ and a tab 534 associated with text ‘CANCEL’. The customer 114 may provide a touch or a click input on the tab 532 for linking the gift card (show by gift card identifier in the text box 520) with the payment card (shown by payment card number in the text box 518) of the customer 114. The selection of the tab 532 may cause display of another UI displaying a text snippet indicating successful linking of the payment card of the customer with the gift card. The tab 534 may be used to cancel the linking of the gift card of with the payment card of the customer 114.

In an embodiment, the merchant terminal 104 causes display of one or more user interfaces (UIs) for receiving approval from the customer 114 for redeeming at least a part of the gift balance amount from the gift card 112 offered by the merchant 102. An example UI displayed to the customer 114 to receive approval for using at least a part of the gift balance amount is shown in FIG. 6A.

Referring now to FIG. 6A, an example representation of a UI 600 displayed to the customer 114 on a display screen of the merchant terminal 104 depicting an approval request to redeem at least a part of a gift balance amount for a transaction amount is illustrated in accordance with an example embodiment of the present disclosure. The UI 600 may be presented to an agent, such as, the agent 108 in response to initiating a payment transaction request (partly depicted in FIG. 6A) at the merchant terminal 104. In at least one example embodiment, the UI 600 may be displayed on the user device 116 via the application interface 500.

The UI 600 is depicted to include a header portion 602, a content portion 604 and an overlay 616. The header portion 602 is depicted to exemplarily display a title associated with text ‘TRANSACTION REQUEST’.

The content portion 604 depicts payment transaction information for the goods/services purchased by the customer 114 at the merchant 102. The payment transaction information is provided by the agent 108 operating the merchant terminal 104. The content portion 604 displays the payment transaction request in fields, such as, payment card type and payment card number of the customer 114 (shown as ‘PAYMENT CARD DETAILS’), a name of the customer (shown as ‘CARDHOLDER’) and a payment amount (shown as ‘TRANSACTION AMOUNT’). Each field from among the fields is depicted to be associated with a payment information displayed in plain text. For example, the field ‘PAYMENT CARD DETAILS’ is associated with a text 606 (“Debit Card, 1234 XXXX XXXX 8891”), the field ‘CARDHOLDER’ is associated with a text 608 (“JOHN”) and the field ‘TRANSACTION AMOUNT’ is associated with a text 610 (“$1000). The fields in the UI 600 and corresponding data may be entered by the agent 108 on the merchant terminal or text 606, 608 may be read from a card reader module of the merchant terminal 104 upon the agent 108 swiping the payment card 118 of the customer 114. The field ‘TRANSACTION AMOUNT’ displays text 610 as provided by the agent 108 based on the goods/service purchased by the customer 114.

As already explained upon the agent 108 swiping the payment card 118 of the customer 114 and providing the transaction amount, the payment transaction request is sent to the payment server 120 that detects a gift card linked with the payment card (“Debit Card, 1234 XXXX XXXX 8891”). The payment server 120 upon detecting the gift card 112 of the merchant 102 linked with the payment card of the customer 114, generates a prompt and provisions display of the prompt as the overlay 616 on display screen of the merchant terminal 104.

The payment server 120 may accordingly recommend redemption of the gift balance amount from the gift card 112 associated with a merchant as shown by an entry 618 in the FIG. 6A. For example, when the payment server 120 detects a gift card for $400 (gift balance amount) offered by the second merchant (M2), the payment server 120 may accordingly recommend redemption of the gift balance amount for payment of at least a part of the transaction amount ($1000). The overlay 616 further configured to depict an option 620 associated with text ‘YES’ and an option 622 associated with text ‘NO’. The customer 114 may provide a click input or selection input on the option 620 if he/she intends to redeem at least a part of the gift balance amount (of the gift card 112) linked with the payment card 118. Alternatively, if the customer 114 prefers to not redeem the gift balance amount of the gift card 112 linked with the payment card 118 for a current purchase, he/she may decline by providing a click input or selection input on the option 622. If the customer declines to use at least a part of the gift balance amount, the transaction amount is debited from an issuer account of the customer associated with the payment card 118.

Referring now to FIG. 6B, an example representation of a UI 630 displayed to the customer 114 on a display screen depicting an approval request for redeeming at least a part of a gift balance amount (redemption amount) for a transaction amount is illustrated in accordance with another example embodiment of the present disclosure. The UI 630 may be presented to the customer 114 on the user device 116 via the application interface 500 for providing an approval for redeeming at least a part of the gift balance amount. In an example embodiment, the UI 630 is presented to the customer 114 on providing a click input or selection input on the option 620 of the overlay 616 (shown in FIG. 6A). In at least one example embodiment, the UI 630 may be displayed on the user device 116 on the display screen of the merchant interface device 106.

The UI 630 is depicted to include a header portion 632 and a content portion 634. The header portion 632 is depicted to exemplarily display a title associated with text ‘GIFT CARD REDEMPTION’.

The content portion 634 depicts gift card details pertaining to gift amount and an available gift balance amount in the gift card 112 via the application interface 500. The content portion 634 displays fields, such as an amount in the gift card 112 (shown as ‘GIFT CARD AMOUNT’) and a balance amount in the gift card 112 (shown as ‘GIFT BALANCE AMOUNT’). In this example representation, the field ‘GIFT CARD AMOUNT’ is associated with a text 636 (“$500”) and the field ‘GIFT BALANCE AMOUNT’ is associated with a text 638 (“$400”). The fields in the UI 630 are determined by the payment server 120 based on a table (see, table 400) maintained at the payment server 120.

The content portion 634 further includes a prompt 640 associated with text “WOULD YOU LIKE TO REDEEM YOUR GIFT AMOUNT FOR YOUR BILL OF $1000 AT KROGER®?”. The content portion 634 further includes a field for the customer 114 to provide a redemption amount (shown as ‘REDEMPTION AMOUNT’) associated with a text box 642. The customer 114 can choose to redeem at least a part of the gift balance amount (shown in the text 638) for payment of the transaction amount (bill amount of $1000) by providing a user preference input that corresponds to a redemption amount in the text box 642.

The content portion 634 is further configured to depict an option 644 associated with text ‘REDEEM’ and an option 646 associated with text ‘CANCEL’. The customer 114 may provide a click input or selection input on the option 644 after providing the redemption amount in the text box 642 if he/she intends to redeem at least a part of the gift balance amount (of the gift card 112) linked with the payment card 118. Alternatively, if the customer 114 prefers to not redeem the gift balance amount of the gift card 112 linked with the payment card 118 for a current purchase, he/she may decline by providing a click input or selection input on the option 644.

Referring now to FIG. 6C, an example representation of a UI 650 displayed to the customer 114 on a display screen depicting an approval request to redeem at least a part of a gift balance amount for a transaction amount is illustrated in accordance with another example embodiment of the present disclosure. In an example embodiment, the UI 650 is displayed to the customer 114 on the merchant terminal 104 when he/she provides the redemption amount on the UI 630 of the application interface 500 associated with the user device 116 (shown in FIG. 6B).

The UI 650 is depicted to include a header portion 652 and a content portion 654. The header portion 652 is depicted to exemplarily display a title associated with text ‘TRANSACTION DETAILS’.

The content portion 654 depicts transaction details in fields, such as a payment card type and payment card number of the customer 114 (shown as ‘PAYMENT CARD DETAILS’), a name of the customer (shown as ‘CARDHOLDER’), a payment amount for goods/services (shown as ‘TRANSACTION AMOUNT’), a part of the gift balance amount redeemed by the customer 114 (shown as ‘REDEMPTION AMOUNT’) and a remaining amount to be deducted from an issuer account of the customer 114 (shown as ‘BALANCE AMOUNT’). Each field is associated with a text as provided by the agent 108 or the customer 114 or data read from the payment card of the customer 114. The text corresponding to each of the field is same as provided by the agent 108 or the user 114 in the UI 600 and/or UI 630 (shown in FIGS. 6A-6B). In this example representation, the field ‘PAYMENT CARD DETAILS’ is associated with a text 656 (“DEBIT CARD, 1234 XXXX XXXX 8891”), the field ‘CARDHOLDER’ is associated with a text 658 (“JOHN”), the field ‘TRANSACTION AMOUNT’ is associated with a text 660 (“$1000”), the field ‘REDEMPTION AMOUNT’ is associated with a text 662 (“$200”) and the field ‘BALANCE AMOUNT’ is associated with a text 664 (“$800”).

The content portion 654 is further configured to depict an option 666 associated with text ‘PAY’ and an option 668 associated with text ‘CANCEL’. The customer 114 may provide a click input or selection input on the option 666 for redeeming at least a part of the gift balance amount (the redemption amount) linked with the payment card 118 and initiate payment of the transaction amount to the merchant (e.g., the merchant 102). Alternatively, if the customer 114 prefers to not redeem the gift balance amount of the gift card 112 linked with the payment card 118 for a current purchase, he/she may decline by providing a click input or selection input on the option 668.

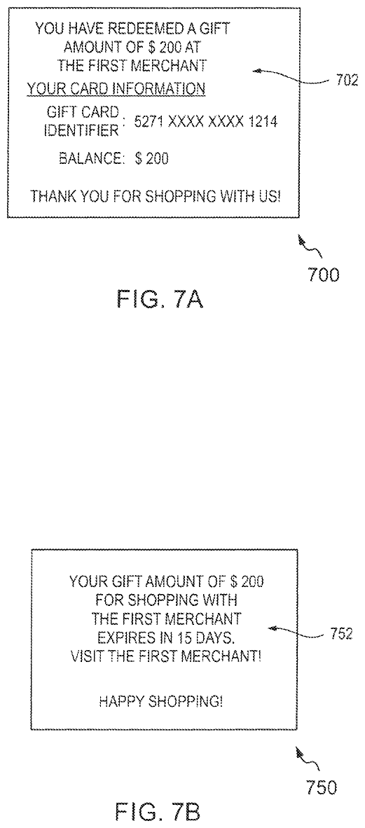

Referring now to FIG. 7A, an example notification 700 provided to the customer 114 depicting redemption of at least a part of a gift balance amount is shown in accordance with an example embodiment of the present disclosure. The notification 700 is generated by the payment server 120 and is displayed on a display screen of the user device 116 (not shown in FIG. 7A).

As explained with reference to FIG. 4, the payment server 120 is configured to track usage information of the gift card 112 for every purchase at the merchant (e.g., the merchant 102). The payment server 120 maintains a table (see, table 400) that tracks and stores information related to the gift cards linked with the payment card 118 of the customer 114. Based on the usage information, a gift balance amount is determined by the payment server 120 after every transaction using the payment card 118 linked with the gift card 112. After redeeming at least a part of the gift balance amount from the gift card 112 based on the redemption amount specified by the user 114 or the gift balance amount debited towards the transaction amount, the payment server 120 may cause display of the notification 700 depicting the gift balance amount debited and a gift balance amount in the gift card 112 linked with the payment card 118 on the user device 116 via the application interface, as shown in FIG. 7A. The notification 700 is depicted to include a text snippet 702.

Referring now to FIG. 7B, an example notification 750 provided to the customer 114 depicting validity of a gift card (e.g., the gift card 112) offered by a merchant, for example, Kroger® and linked with the payment card 118 is shown in accordance with an example embodiment of the present disclosure. The notification 750 is generated by the payment server 120 and is displayed on a display screen of the user device 116 (not shown in FIG. 7B).

As explained with reference to FIG. 4, the payment server 120 maintains a table (see, table 400) that tracks and stores information related to the gift cards linked with the payment card 118 of the customer 114. The validity of the gift card 112 is tracked by the payment server 120 and the payment server 120 is configured to send notifications to the customer 114 indicating expiry of the gift card based on the validity mentioned in a validity of gift card field 414 (shown in FIG. 4). The payment server 120 may be configured to send periodic notifications, for example, notifications are sent at pre-defined intervals about the validity of the gift card and the gift balance amount in the gift card 112.

The notification 750 is depicted to include a text snippet 752 as shown in FIG. 7B.

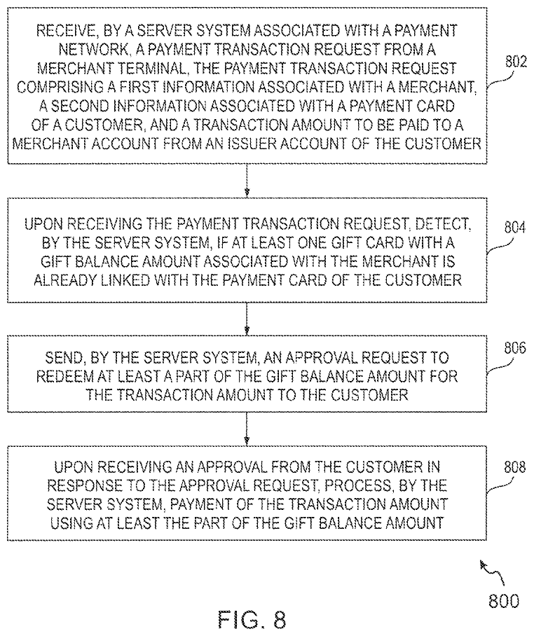

Referring now to FIG. 8, a flow diagram depicting a method 800 for redeeming a gift card linked with a payment card of the customer is illustrated in accordance with an example embodiment of the present disclosure. The method 800 depicted in the flow diagram may be executed by, for example, the payment server 120. Operations of the flow diagram, and combinations of operation in the flow diagram, may be implemented by, for example, hardware, firmware, a processor, circuitry and/or a different device associated with the execution of software that includes one or more computer program instructions. The operations of the method 800 are described herein with help of the payment server 120. It is noted that the operations of the method 800 can be described and/or practiced by using a system other than the payment server 120, such as the acquirer server 124 or the issuer server 122. The method 800 starts at operation 802.

At operation 802, the method 800 includes receiving, by a server system associated with a payment network, a payment transaction request from a merchant terminal. The payment transaction request includes a merchant information associated with a merchant, a payment card information of a payment card of the customer and a transaction amount to be paid to a merchant account from an issuer account of the customer. The payment card information may be scanned/read at the merchant terminal 104 and the transaction amount corresponds to goods/services bought by the customer and may be keyed-in by an agent associated with the merchant terminal 104. The merchant information may include a name, a merchant identifier and merchant account details of the merchant. In an embodiment, the payment transaction request is sent from the merchant terminal 104 to the acquirer server 124 associated with the merchant terminal 104. In another embodiment, the merchant terminal 104 sends the payment transaction request to the acquirer server 124 that forwards the payment transaction request to the payment server 120. The transmission of the payment transaction request is provisioned between the servers through the payment network 128.

At operation 804, the method 800 includes upon receiving the payment transaction request, detecting, by the server system, if at least one gift card with a gift balance amount associated with the merchant is already linked with the payment card of the customer. For example, the payment server 120 may use the merchant identifier to look up into a table (see, table 400) at the payment server 120 for identifying if the payment card 118 is linked with any gift card offered by the merchant associated with the merchant identifier. If the payment server 120 detects at least one gift card, for example, the gift card of the merchant 102, the payment server 120 retrieves details of the gift card from the table. In at least one example embodiment, the customer 114 may have linked the gift card with the payment card 118 of the customer prior to redeeming the gift card. The linking of the gift card with the payment card creates an entry in the table maintained at the payment server 120.

At operation 806, the method 800 includes sending, by the server system, an approval request to redeem at least a part of the gift balance amount for the transaction amount to the customer. The payment server 120 causes the merchant terminal 104 at the merchant 102 to display the approval request for redeeming at least a part of the gift balance amount. The approval request is displayed as a prompt for the user 114 to provide consent for redeeming the gift card 112 at the merchant 102. Additionally or optionally, the customer may be prompted to provide a redemption amount from the gift balance amount. The customer may choose to redeem a part of the gift balance amount or an entire gift balance amount. An example UI depicting redemption of at least a part of the gift balance amount is explained with reference to FIG. 6B.

At operation 808, the method 800 includes upon receiving an approval from the customer in response to the approval request, processing, by the server system, payment of the transaction amount using at least the part of the gift balance amount. The payment server 120 is configured to determine a gift balance amount in the gift card linked with the payment card of the customer. In one embodiment, the payment server 120 places a hold on the gift balance amount and upon receiving the approval from the customer, determines a balance amount to be debited from an issuer account of the customer for the transaction amount. In at least one example embodiment, the customer provides the redemption amount (a part of the gift balance amount) and the payment server 120 determines the balance amount based on a difference of the transaction amount and the redemption amount.

The sequence of operations of the method 800 need not be necessarily executed in the same order as they are presented. Further, one or more operations may be grouped together and performed in form of a single step, or one operation may have several sub-steps that may be performed in parallel or in sequential manner.

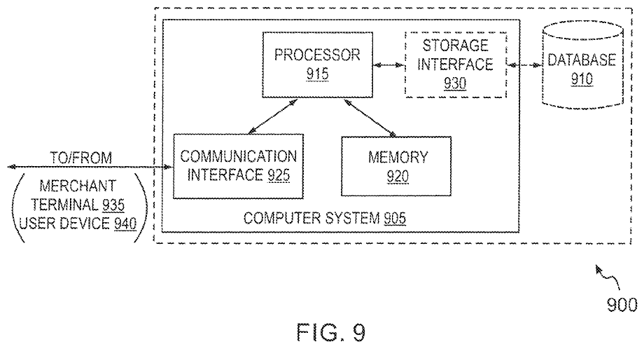

FIG. 9 is a simplified block diagram of a server system 900 for redeeming a gift card (e.g., the gift card 112) at a merchant terminal 104 of the merchant 102, in accordance with an embodiment of the present disclosure. Examples of the server system 900 include, but not limited to, the acquirer server 124, the issuer server 122 and the payment server 120 illustrated in FIG. 1. The server system 900 includes a computer system 905 and a database 910.

The computer system 905 includes at least one processor 915 for executing instructions. Instructions may be stored in, for example, but not limited to, a memory 920. The processor 915 may include one or more processing units (e.g., in a multi-core configuration).

The processor 915 is operatively coupled to a communication interface 925 such that the computer system 905 is capable of communicating with a remote device such as a merchant terminal 935 (e.g., the merchant terminal 104), a user device 940 (e.g., the user device 116) or communicates with any entity within the payment network 128. For example, the communication interface 925 may receive a registration request from the user device 940 for linking the gift card 112 with the payment card 118 of the customer 114 and/or a payment transaction request from the merchant terminal 935 for payment of at least a part of a transaction amount from a gift balance amount in the gift card 112 at the merchant terminal 935.

The processor 915 may also be operatively coupled to the database 910. The database 910 is any computer-operated hardware suitable for storing and/or retrieving data, such as, but not limited to, transaction data generated as part of sales activities conducted over the bankcard network including data relating to merchants, account holders or customers, and purchases. The database 910 may also store information related to a plurality of user's issuer accounts. Each user account data includes at least one of a cardholder name, a cardholder address, an account number, one or more gift cards linked with a payment card of the cardholder, a gift balance amount in each of the one or more gift cards, a merchant identifier of the merchant offering the gift card, validity of the one or more gift cards, and other account identifier. The database 910 may also store information of a plurality of merchants, plurality of merchant terminals installed at merchant facilities, such as merchant terminal ID, location of merchant terminals etc. The database 910 may also include instructions for settling transactions including merchant bank account information, determining balance amount to be debited from the issuer account of the cardholder based on gift balance amount/redemption amount. The database 910 may include multiple storage units such as hard disks and/or solid-state disks in a redundant array of inexpensive disks (RAID) configuration. The database 910 may include a storage area network (SAN) and/or a network attached storage (NAS) system.

In some embodiments, the database 910 is integrated within the computer system 905. For example, the computer system 905 may include one or more hard disk drives as the database 910. In other embodiments, the database 910 is external to the computer system 905 and may be accessed by the computer system 905 using a storage interface 930. The storage interface 930 is any component capable of providing the processor 915 with access to the database 910. The storage interface 930 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 915 with access to the database 910.

The processor 915 is configured to process a payment of the transaction amount from at least a part of the gift balance amount to an acquirer account (merchant account). The processor 915 is configured to receive a registration request for linking a gift card with the payment card of the cardholder prior to redemption, verify and validate the registration request and link the gift card with the payment card. The processor 915 is further configured to perform one or more of the functions such as: receive a payment transaction request, detect one or more gift cards for a merchant linked with the payment card of the cardholder, determine a gift balance amount in each of the gift cards detected for the merchant, send an approval request to the cardholder for redemption of at least a part of the gift balance amount and determine a balance amount to be debited from an issuer account of the cardholder. The processor 915 is further configured to check the authentication of the cardholder by verifying the payment card number, PIN/OTP or QR code, validity of the payment card by accessing respective information from the database 910. Thereafter, the processor 915 is configured to process the payment transaction of the transaction amount from the issuer account of the customer 114 to the acquirer account of the merchant 102 using at least a part of the gift balance amount. The processor 915 may also be configured to notify the merchant terminal 935 and/or the user device 940 of the transaction status via the communication interface 925.

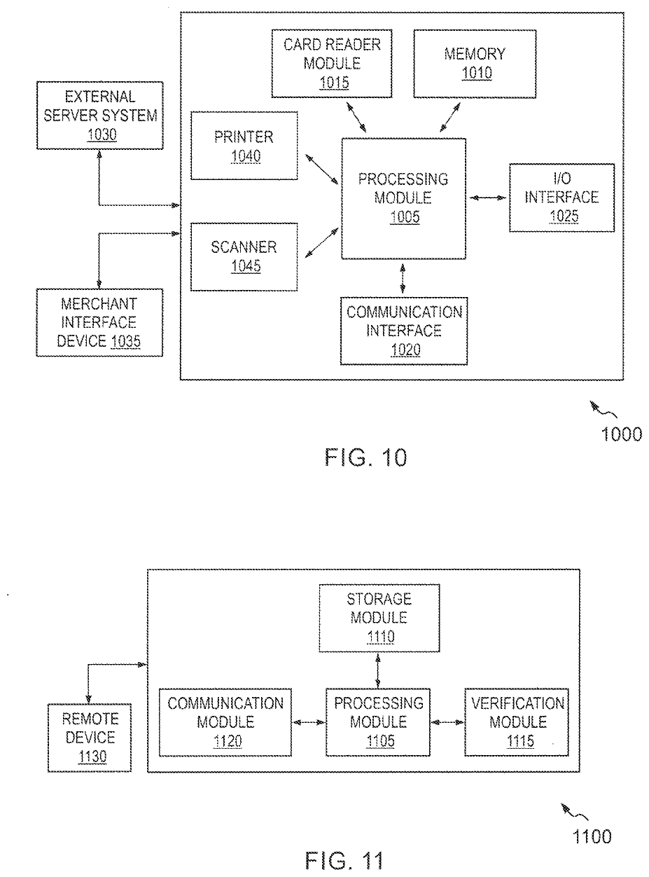

FIG. 10 is a simplified block diagram of a merchant terminal 1000 of a merchant (e.g., the merchant 102) used for redeeming a gift card offered by the merchant, in accordance with an embodiment of the present disclosure. The term merchant terminal 1000 (also referred to as a ‘POS terminal 1000’) may refer to a system including a host computer connected to several peripheral devices, such as a keyboard, and a mouse, a card reader, a barcode scanner, a receipt printer, a cash drawer, and a weighing scale. However, it shall be noted that herein the POS terminal 1000 is referred to the POS machine which is used to swipe payment cards.

The POS terminal 1000 includes at least one processing module 1005 communicably coupled to a memory 1010, a card reader module 1015, a communication interface 1020, and a printer 1040. The components of the POS terminal 1000 provided herein may not be exhaustive, and that the POS terminal 1000 may include more or fewer components than that of depicted in FIG. 10. Further, two or more components may be embodied in one single component, and/or one component may be configured using multiple sub-components to achieve the desired functionalities. Some components of the POS terminal 1000 may be configured using hardware elements, software elements, firmware elements and/or a combination thereof.

The card reader module 1015 is configured to read information from a chip of a payment card (e.g., the payment card 118). The card reader module 1015 is also configured to read information stored within magnetic stripes provided in some payment cards. There may be as many as two card reader modules in the POS terminal 1000 that each of which may be configured to read information stored in different types of storages, such as chips and magnetic stripes.

An I/O interface 1025 is configured to receive inputs from an end-user and provide outputs to the end-user (i.e. the agent 108 and/or the customer 114) of the POS terminal 1000. For instance, the I/O interface 1025 may include at least one input interface and/or at least one output interface. Examples of the input interface may include, but are not limited to, a keyboard, a keypad, a touch screen, soft keys and the like. The input interface (also referred to as ‘input module’) may be used to provide transaction amount, a PIN, a reference code and a user preference input for redeeming at least a part of a gift balance amount in a gift card (e.g., the gift card 112). Examples of the output interface may include, but are not limited to, a UI display (such as a light emitting diode display, a thin-film transistor (TFT) display, a liquid crystal display, an active-matrix organic light-emitting diode (AMOLED) display, etc.) and the like. The output interface (also referred to as ‘output module’) may be used to display transaction details, an approval request for the customer (e.g., the customer 114) to receive a consent of the customer for redeeming at least a part of the gift balance amount and the customer 114 (or the agent 108) may provide a selection input on an option to approve the transaction request via the input interface. Further, the output interface may optionally display a notification depicting payment transaction status such as, payment transaction approval or decline upon transferring the transaction amount to an acquirer account of the merchant.

The printer 1040 is configured to print receipts of the transaction. The receipt includes an acquirer bank name, the transaction amount, merchant name, date on which the receipt is printed and a payment card type, among other information.

The memory 1010 can be any type of storage accessible to the processing module 1005. For example, the memory 1010 may include volatile or non-volatile memories, or a combination thereof. In some non-limiting examples, the memory 1010 can be four to sixty four Megabytes (MB) of Dynamic Random Access Memory (“DRAM”) or Static Random Access Memory (“SRAM”). In addition, some examples may include supplementary flash memory installed via a PCMCIA slot. Moreover, the memory 1010 is capable of storing and/or retrieving data, such as, but not limited to, smart card insertions, user/customer information, merchant information, card swipes, touch-screen key depressions, keypad key depressions, number of dots printed by the slip and roll printers, check read errors, and the like. Such information can be accessed by the processing module 1005 using the communication interface 1020 to determine potential future failures and the like.

The POS terminal 1000 is capable of communicating with one or more POS peripheral devices such as a merchant interface device 1035 and an external server system 1030 such as the acquirer server 124 (shown in FIG. 1) via the communication interface 1020 over a communication network (not shown). The merchant interface device 1035 can provide functionality which is used by a consumer (e.g., the customer 114) at a merchant facility (e.g., the merchant 102), such as unique reference code (e.g., QR code) entry corresponding to the payment card of the customer 114, PIN entry, clear text entry, signature capture, and the like. The POS terminal 1000 includes a scanner 1045 configured to read a machine-readable encrypted code such as the unique reference code that may be generated by the user device 116 for the payment card information. The scanner 1045 may be a barcode scanner or a QR code scanner. The merchant interface device 1035 may be connected to several peripheral devices including cash drawers, receipt printers, PIN pads, signature capture devices and the like. In some embodiments, the merchant interface device 1035 may be mounted near a cash register at a check-out counter at a merchant facility, while the POS terminal 1000 may be mounted on the check-out counter such that it is accessible to customers. In this way, both the merchant and the user/customer can interact with similar devices to process the payment transaction.

The communication interface 1020 is further configured to cause display of one or more user interfaces on the POS terminal 1000 for receiving user input from an agent (e.g., the agent 108) operating the POS terminal 1000 such as to process payment of the transaction amount by redeeming at least a part of the gift balance amount from the gift card offered by the merchant 102. In one embodiment, the communication interface 1020 includes a transceiver for wirelessly communicating information (transaction amount, merchant identifier, etc.) to, or receiving information from, the external server system 1030 or other suitable display device, and/or another type of remote processing device. In another embodiment, the communication interface 1020 is capable of providing operative communication with the remote devices and a cloud server using Application Program Interface (API) calls. The communication may be achieved over a communication network.

The processing module 1005 is capable of sending the payment transaction request received from the end-user via the communication interface 1020 to the external server system 1030 for processing the payment transaction. For example, the processing module 1005 is configured to receive the PIN, the approval of the customer for redeeming at least a part of the gift balance amount, the transaction amount and optionally the redemption amount using the UIs. The processing module 1005 can access the memory 1010 to retrieve the merchant information of the merchant 102 such as, merchant identifier merchant account details that are required to be sent along with the payment transaction request to the external server system 1030. Further, the processing module 1005 is caused to modify a gift card identifier flag upon receiving the approval from the customer 114 for redeeming at least a part of the gift balance amount for the transaction amount. The gift card identifier flag indicates if the transaction amount has to be debited entirely from an issuer account of the customer or if at least a part of the gift balance amount may be used for the transaction amount.

Additionally, the POS terminal 1000 can include an operating system and various software applications that can provide various functionalities to the POS terminal 1000. For example, in some embodiments, the POS terminal 1000 is addressable with an Internet protocol and includes an application. In such embodiments, the processing module 1005 includes software adapted to support such functionality. In some embodiments, the processing module 1005 executes software to support network management. In particular, this capacity allows software to be downloaded to a plurality of such systems to provide new applications such as application for various possible payment methods using POS terminals and/or updates to existing applications. The operating system and software application upgrades are distributed and maintained through communication to the POS terminal 1000 over the payment network 128.

FIG. 11 is a simplified block diagram of an issuer server 1100 used for performing payment of at least a part of a transaction amount with a payment card, in accordance with an embodiment of the present disclosure. The issuer server 1100 is an example of the issuer server 122 of FIG. 1, or may be embodied in the issuer server 122. The issuer server 1100 is associated with an issuing bank/issuer, in which a customer (e.g., the customer 114) may have an account, which provides a payment card. The issuer server 1100 includes a processing module 1105 operatively coupled to a storage module 1110, a verification module 1115, and a communication module 1120. The components of the issuer server 1100 provided herein may not be exhaustive and that the issuer server 1100 may include more or fewer components than that of depicted in FIG. 11. Further, two or more components may be embodied in one single component, and/or one component may be configured using multiple sub-components to achieve the desired functionalities. Some components of the issuer server 1100 may be configured using hardware elements, software elements, firmware elements and/or a combination thereof.

The storage module 1110 is configured to store machine executable instructions to be accessed by the processing module 1105. Additionally, the storage module 1110 stores information related to, contact information of the customer, bank account number, availability of funds in the account, payment card details, transaction details and/or the like. This information is retrieved by the processing module 1105 for validation during payment/refund.

The processing module 1105 is configured to communicate with one or more remote devices such as a remote device 1130 using the communication module 1120 over a network such as the payment network 128 of FIG. 1. The examples of the remote device 1130 include the merchant terminal 104, the payment server 120, the acquirer server 124 and an external database (not shown) or other computing systems of issuer and the payment network 128. The communication module 1120 is capable of provisioning such operative communication with the remote devices and cloud servers using API (Application Program Interface) calls. The communication module 1120 is configured to receive payment transaction request from the merchant terminal 104 via the payment network 128. The communication module 1120 is configured to send notification of approval or decline of a transaction/refund to the merchant terminal 104 via the payment network 128. The processing module 1105 receives a balance amount, the merchant information and the PIN from the remote device 1130 (i.e. the merchant terminal 104 or the payment server 120).

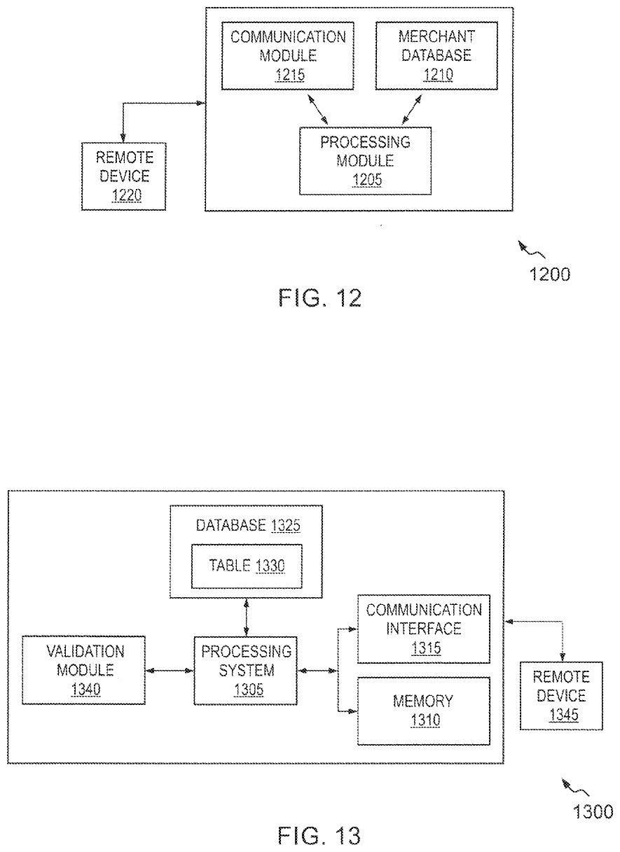

FIG. 12 is a simplified block diagram of an acquirer server 1200 for processing payment transactions using a payment card linked with at least one gift card at a merchant terminal, in accordance with an embodiment of the present disclosure. The acquirer server 1200 is associated with an acquirer, which may be associated with the merchant 102 at whose facility the customer 114 is purchasing items. The merchant 102 may have established an account to accept payment for purchase of items from customers. The acquirer server 1200 is an example of the acquirer server 124 of FIG. 1 or may be embodied in the acquirer server 124. Further, the acquirer server 1200 is configured to process payment/refund with the issuer server 122 using the payment network 128 of FIG. 1.

The acquirer server 1200 includes a processing module 1205 communicably coupled to a merchant database 1210 and a communication module 1215. The components of the acquirer server 1200 provided herein may not be exhaustive, and that the acquirer server 1200 may include more or fewer components than that of depicted in FIG. 12. For instance, the acquirer server 1200 may include a registration module that is configured for registration of one or more gift cards of the customer 114 with the payment card 118 of the customer 114. Further, two or more components may be embodied in one single component, and/or one component may be configured using multiple sub-components to achieve the desired functionalities. Some components of the acquirer server 1200 may be configured using hardware elements, software elements, firmware elements and/or a combination thereof.

The merchant database 1210 includes data of one or more merchant parameters, such as, but not limited to, a merchant primary account number (PAN), a merchant name, a merchant ID (MID), a merchant category code (MCC), a merchant city, a merchant postal code, a merchant brand name, terminal identification numbers (TIDs) associated with merchant terminals (e.g., the POS terminal 104 or any other merchant electronic devices) used for processing transactions. The processing module 1205 is configured to use the MID or any other merchant parameter such as the merchant PAN to identify the merchant during the normal processing of payment transactions, refunds, adjustments, chargebacks, end-of-month fees, loyalty programs associated with the merchant and so forth. The processing module 1205 may be configured to store and update the merchant parameters in the merchant database 1210 for later retrieval. In an embodiment, the communication module 1215 is capable of provisioning operative communication with a remote device 1220, such as, the merchant terminal 104. The communication module 1215 is configured to receive the payment transaction request from the remote device 1220 (e.g., the merchant terminal 104) and optionally a gift card identifier flag for identifying if at least a part of the payment is from a gift balance amount of a gift card (e.g., the gift card 112) linked with the payment card 118 of the customer 114.

FIG. 13 is a simplified block diagram of a payment server 1300 used for redeeming at least a part of a gift balance amount from a gift card (e.g., the gift card 112) linked with a payment card (e.g., the payment card 118) of a customer at a merchant terminal, in accordance with an embodiment of the present disclosure. The payment server 1300 is an example of the payment server 120 of FIG. 1. The payment network 128 may be used by the payment server 1300, the issuer server 1100 and the acquirer server 1200 as a payment interchange network. The payment server 1300 includes a processing system 1305 configured to extract programming instructions from a memory 1310 to provide various features of the present disclosure. The components of the payment server 1300 provided herein may not be exhaustive and that the payment server 1300 may include more or fewer components than that of depicted in FIG. 13. Further, two or more components may be embodied in one single component, and/or one component may be configured using multiple sub-components to achieve the desired functionalities. Some components of the payment server 1300 may be configured using hardware elements, software elements, firmware elements and/or a combination thereof.

Via a communication interface 1315, the processing system 1305 receives request from a remote device 1345 such as the acquirer server 1200, the POS terminal 1000 or a merchant device (e.g., the merchant interface device 106) associated with the merchant 102. The request may be a request for payment transaction, a request to identify one or more gift cards that may be linked with the payment card 118 of the customer 114 or determine a gift balance amount in the gift card 112 of the customer 114. The communication may be achieved through API calls, without loss of generality. The payment server 1300 includes a table 1330 embodied in a database 1325. The table 1330 includes payment card information of a plurality of customers and information pertaining to one or more gift cards linked with the payment card. The payment card information includes details such as, payment card number, name of the customer and a customer identifier. The information associated with the one or more gift cards linked with the payment card may be a gift card identifier, a gift balance amount and a validity of the gift card. An example of the table 1330 is shown and explained with reference to FIG. 4. The database 1325 also includes transaction processing data such as, Issuer ID, POS ID, country code, acquirer ID, MID, among others. The one or more gift cards are linked with the payment card upon receiving a registration request from the remote device 1345 such as, the user device 116 equipped with an application interface.

When the payment server 1300 receives a payment transaction request from the acquirer server 1200 or the POS terminal 1000, the payment server 1300 may perform a lookup into the table 1330 to detect one or more gift cards for the merchant 102 linked with the payment card of the customer. The database 1325 stores transaction identifiers for identifying transaction details such as, transaction amount, payment card details, acquirer account information, transaction records, merchant account information, redemption amount, refund information and the like.

The processing system 1305 determines a balance amount to be debited from an issuer account of the customer (based on payment card information) based on the redemption amount or the gift balance amount. The customer details, the payment card information, the issuer account balance, the redemption amount (or the gift balance amount), the balance amount is validated using a validation module 1340. The validation module 1340 may include one or more predefined rule sets using which the processing system 1305 can process the validation. Further, the processing system 1305, upon successful validation, sends the transaction amount and the merchant parameters (i.e. merchant account information) to the acquirer server 1200 for crediting the merchant account with the transaction amount. The processing system 1305 is further configured to send a transaction request comprising the balance amount to the issuer server 1100 for processing payment transaction from the remote device 1345 (e.g., the POS terminal 1000). The processing system 1305 is further configured to notify the remote device 1345 of the transaction status via the communication interface 1315. In one embodiment, the processing system 1305 may provision a dedicated application interface capable of being installed on the user device 116. In an embodiment, the payment server 1300 sends a redemption request on the application interface for redeeming at least a part of the gift balance amount from the gift card of the merchant for the transaction amount. The customer (e.g., the customer 114) may be enabled to view the transaction status using the application interface on the user device 116. The customer 114 may access the application interface using a web link as well, instead of having a need to install the application on the user device 116.

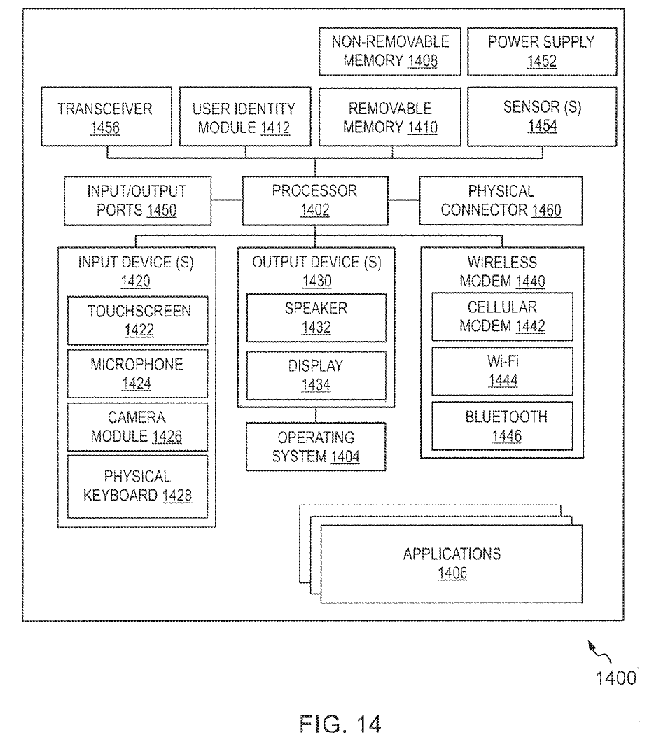

FIG. 14 shows simplified block diagram of a user device 1400, for example, a mobile phone capable of implementing at least some embodiments of the present disclosure. The user device 1400 is depicted to include one or more applications 1406. The user device 1400 is an example of the user device 116.

It should be understood that the user device 1400 as illustrated and hereinafter described is merely illustrative of one type of device and should not be taken to limit the scope of the embodiments. As such, it should be appreciated that at least some of the components described below in connection with that the user device 1400 may be optional and thus in an example embodiment may include more, less or different components than those described in connection with the example embodiment of the FIG. 14. As such, among other examples, the user device 1400 could be any of an electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1400 includes a controller or a processor 1402 (e.g., a signal processor, microprocessor, ASIC, or other control and processing logic circuitry) for performing such tasks as signal coding, data processing, image processing, input/output processing, power control, and/or other functions. An operating system 1404 controls the allocation and usage of the components of the user device 1400 and support for one or more applications programs (see, the applications 1406), such as an application interface 500 for linking of a gift card with a payment card of the customer 114. Additionally, the application interface may be accessed to redeem at least a part of a gift balance amount from the gift card (e.g., the gift card 112) linked with the payment card 118 of the customer 114. In addition to the application interface, the applications 1406 may include common mobile computing applications (e.g., telephony applications, email applications, calendars, contact managers, web browsers, messaging applications such as USSD messaging or SMS messaging or SIM Tool Kit (STK) application) or any other computing application.

The illustrated user device 1400 includes one or more memory components, for example, a non-removable memory 1408 and/or a removable memory 1410. The non-removable memory 1408 and/or the removable memory 1410 may be collectively known as database in an embodiment. The non-removable memory 1408 can include RAM, ROM, flash memory, a hard disk, or other well-known memory storage technologies. The removable memory 1410 can include flash memory, smart cards, or a Subscriber Identity Module (SIM). The one or more memory components can be used for storing data and/or code for running the operating system 1404 and the applications 1406. The user device 1400 may further include a user identity module (UIM) 1412. The UIM 1412 may be a memory device having a processor built in. The UIM 1412 may include, for example, a subscriber identity module (SIM), a universal integrated circuit card (UICC), a universal subscriber identity module (USIM), a removable user identity module (R-UIM), or any other smart card. The UIM 1412 typically stores information elements related to a mobile subscriber. The UIM 1412 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1400 can support one or more input devices 1420 and one or more output devices 1430. Examples of the input devices 1420 may include, but are not limited to, a touch screen/a screen 1422 (e.g., capable of capturing finger tap inputs, finger gesture inputs, multi-finger tap inputs, multi-finger gesture inputs, or keystroke inputs from a virtual keyboard or keypad), a microphone 1424 (e.g., capable of capturing voice input), a camera module 1426 (e.g., capable of capturing still picture images and/or video images) and a physical keyboard 1428. Examples of the output devices 1430 may include, but are not limited to a speaker 1432 and a display 1434. Other possible output devices can include piezoelectric or other haptic output devices. Some devices can serve more than one input/output function. For example, the touch screen 1422 and the display 1434 can be combined into a single input/output device.

A wireless modem 1440 can be coupled to one or more antennas (not shown in the FIG. 14) and can support two-way communications between the processor 1402 and external devices, as is well understood in the art. The wireless modem 1440 is shown generically and can include, for example, a cellular modem 1442 for communicating at long range with the mobile communication network, a Wi-Fi compatible modem 1444 for communicating at short range with an external Bluetooth-equipped device or a local wireless data network or router, and/or a Bluetooth-compatible modem 1446. The wireless modem 1440 is typically configured for communication with one or more cellular networks, such as a GSM network for data and voice communications within a single cellular network, between cellular networks, or between the user device 1400 and a public switched telephone network (PSTN).

The user device 1400 can further include one or more input/output ports 1450 for establishing connection with peripheral devices including the POS terminal 1000, a power supply 1452, one or more sensors 1454 for example, an accelerometer, a gyroscope, a compass, or an infrared proximity sensor for detecting the orientation or motion of the user device 1400 and biometric sensors for scanning biometric identity of an authorized user, a transceiver 1456 (for wirelessly transmitting analog or digital signals) and/or a physical connector 1460, which can be a USB port, IEEE 1294 (FireWire) port, and/or RS-232 port. The illustrated components are not required or all-inclusive, as any of the components shown can be deleted and other components can be added.

With the application (see, the applications 1406) and/or other software or hardware components, the user device 1400 can implement the technologies described herein. For example, the processor 1402 can cause generation of one or more UIs for receiving gift card information (offered by the merchant 102) and payment card information of the customer, providing an approval for redeeming at least a part of the gift balance amount, providing a user preference input corresponding to a redemption amount from the gift balance amount and displaying notifications of successful linking of the gift card (offered by the merchant) with the payment card of the customer and/or payment transaction status.

The disclosed methods with reference to FIGS. 1 to 3A-3D, or one or more operations of the flow diagram 800 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 900 (e.g., servers 120, 122, 124 and 126) and its various components such as the computer system 905 and the database 910 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method, comprising:
receiving, by a server system associated with a payment network, a payment transaction request from a merchant terminal, the payment transaction request comprising
a first information associated with a merchant,
a second information associated with a payment card of a customer, and
a transaction amount to be paid to a merchant account from an issuer account of the customer;
upon receiving the payment transaction request, detecting, by the server system, if at least one gift card with a gift balance amount associated with the merchant is already linked with the payment card of the customer;
sending, by the server system, an approval request to redeem at least a part of the gift balance amount for the transaction amount to the customer; and
upon receiving an approval from the customer in response to the approval request, processing, by the server system, a payment of the transaction amount using at least the part of the gift balance amount.

2. The method as claimed in claim 1, further comprising linking a gift card with the payment card by performing at least:
receiving, by the server system, a registration request from a user device, the registration request comprising at least the second information, a merchant identifier associated with the gift card, a gift card identifier associated with the gift card and the gift balance amount of the gift card; and
upon verification of the registration request, storing, by the server system, the merchant identifier, the gift card identifier, the gift balance amount of the gift card with the second information thereby linking the gift card with the payment card.

3. The method as claimed in claim 2, wherein the merchant terminal is at least one of a point of sale terminal and a merchant online interface.

4. The method as claimed in claim 2, further comprising:
tracking, by the server system, the gift balance amount in the gift card of the customer after every purchase at the merchant using the gift card.

5. The method as claimed in claim 1, further comprising:
receiving, by the server system, a user preference input comprising a redemption amount for redeeming at least the part of the gift balance amount for processing the payment of the transaction amount from the gift balance amount, wherein the user preference input is received in response to the approval request sent by the server system to one of the merchant terminal and a user device.

6. The method as claimed in claim 5, further comprising:
determining, by the server system, a balance amount to be deducted from the issuer account, the balance amount being a difference of the transaction amount and the redemption amount; and
processing, by the server system, a payment of the balance amount from the issuer account of the customer to the merchant account of the merchant.

7. The method as claimed in claim 1, further comprising:
sending, by the server system, a notification to the merchant terminal, the notification comprising a payment transaction approval message of the payment and a redemption of the gift balance amount from the gift card.

8. The method as claimed in claim 1, further comprising:
receiving, by the server system, a gift card identifier flag from the merchant terminal as part of receipt of the approval from the customer;
determining, by the server system, the gift balance amount in the gift card of the customer;
sending a redemption request of a user device of the customer for redeeming at least a part of the gift balance amount; and
receiving a user preference input comprising a redemption amount from the gift balance amount, wherein the redemption amount is used by the payment server for the payment of the transaction amount.

9. The method as claimed in claim 1, wherein the payment card is at least one of: a credit card, a debit card, and a digital wallet.

10. A server system, comprising:
a memory comprising stored instructions; and
at least one processor, configured to execute the stored instructions to cause the server system to perform at least
receiving a payment transaction request from a merchant terminal, the payment transaction request comprising a first information associated with a merchant, a second information associated with a payment card of a customer and a transaction amount to be paid to a merchant account from an issuer account of the customer,
upon receiving the payment transaction request, detecting if at least one gift card with a gift balance amount associated with the merchant is already linked with the payment card of the customer,
sending an approval request to redeem at least a part of the gift balance amount for the transaction amount to the customer, and
upon receiving an approval from the customer in response to the approval request, processing a payment of the transaction amount using at least the part of the gift balance amount.

11. The server system as claimed in claim 10, wherein for linking a gift card with the payment card, the server system is further caused to perform at least:
receiving a registration request from a user device, the registration request comprising at least the second information, a merchant identifier associated with the gift card, a gift card identifier associated with the gift card and the gift balance amount of the gift card; and
upon verification of the registration request, storing the merchant identifier, the gift card identifier, the gift balance amount of the gift card with the second information thereby linking the gift card with the payment card.

12. The server system as claimed in claim 11, wherein the merchant terminal is at least one of a point of sale terminal and a merchant online interface.

13. The server system as claimed in claim 11, wherein the server system is further caused to perform:
tracking of the gift balance amount in the gift card of the customer after every purchase at the merchant using the gift card.

14. The server system as claimed in claim 10, wherein the server system is further configured to perform:
receiving a user preference input comprising a redemption amount for redeeming at least the part of the gift balance amount for processing the payment of the transaction amount from the gift balance amount, wherein the user preference input is received in response to the approval request sent by the server system to one of the merchant terminal and a user device.

15. The server system as claimed in claim 14, wherein the server system is further configured to perform:
determining a balance amount to be deducted from the issuer account, the balance amount being a difference of the transaction amount and the redemption amount; and
processing a payment of the balance amount from the issuer account of the customer to the merchant account of the merchant.

16. The server system as claimed in claim 10, wherein the server system is further configured to perform:
receiving a gift card identifier flag from the merchant terminal as part of receipt of the approval from the customer;
determining the gift balance amount in the gift card of the customer;
sending a redemption request of a user device of the customer for redeeming at least a part of the gift balance amount; and
receiving a user preference input comprising a redemption amount from the gift balance amount, wherein the redemption amount is used by the payment server for the payment of the transaction amount.

17. The server system as claimed in claim 10, wherein the server system is further configured to perform:
sending a notification to the merchant terminal, the notification comprising a payment transaction approval message of the payment and a redemption of the gift balance amount from the gift card.

18. A merchant terminal, comprising:
a memory comprising stored instructions; and
at least one processing module in operable communication with the memory, the at least one processing module configured to execute the stored instructions to cause the merchant terminal to perform at least
sending a payment transaction request to a server system associated with a payment network, the payment transaction request comprising a first information associated with a merchant, a second information associated with a payment card of a customer and a payment transaction amount to be paid to a merchant account from an issuer account of the customer,
displaying an approval request on a display screen for receiving an approval from the customer to redeem at least a part of a gift balance amount associated with a gift card of the customer, the approval request received from the server system in response to detecting the gift card of the merchant already linked with the payment card by the server system,
providing a user preference input comprising a redemption amount to the server system, the redemption amount being an amount from the gift balance amount that the customer wants to redeem for the transaction amount, and
receiving a notification comprising a payment transaction approval message of the payment and a redemption of at least the part of the gift balance amount from the gift card.

19. The merchant terminal as claimed in claim 18, wherein the merchant terminal is a point of sale (POS) terminal.

20. The merchant terminal as claimed in claim 18, wherein the merchant terminal is a merchant online interface.
